(19) United States
(12) Patent Application Publication
(10) Pub. No.: US 2023/0256795 A1
(43) Pub. Date: Aug. 17, 2023

(54) VEHICLE DOOR, VEHICLE, AND VEHICLE MANUFACTURING METHOD

(71) Applicant: TS TECH CO., LTD., Saitama (JP)

(72) Inventors: Hiroyuki NUMAJIRI, Tochigi (JP); Shoji KOTSUKA, Tochigi (JP); Masanori SUZUKI, Tochigi (JP); Tsutomu MATSUZAKI, Tochigi (JP); Jinichi TANABE, Tochigi (JP); Ryuzaburo ABE, Tochigi (JP)

(21) Appl. No.: 18/304,484

(22) Filed: Apr. 21, 2023

Related U.S. Application Data
(63) Continuation of application No. PCT/JP2021/039024, filed on Oct. 21, 2021.
(60) Provisional application No. 63/094,973, filed on Oct. 22, 2020.
(60) Provisional application No. 63/115,119, filed on Nov. 18, 2020.

(30) Foreign Application Priority Data
Feb. 3, 2021 (JP) 2021-015793

(51) Int. Cl. B60J 5/04

(52) U.S. Cl. CPC B60J 5/0423; B60J 5/0469

(57) ABSTRACT

Provided is a vehicle interior component capable of exhibiting an in-vehicle lighting function even without electricity supply from a vehicle body power source.

A vehicle interior component attached to a vehicle is a vehicle door lining, which includes a light-emitting member emitting light toward the inside of the vehicle, a power generation member electrically connected to the light-emitting member and supplying electricity to the light-emitting member, and a power storage member electrically connected to the light-emitting member and the power generation member and storing electricity. The light-emitting member, the power generation member, and the power storage member are disposed at different positions on the surface of the vehicle door lining on the vehicle inside. In addition, the power generation member is sheet-shaped or film-shaped and is disposed along the surface of the vehicle door lining.

### BACKGROUND OF THE INVENTION

### Field of the Invention

### CROSS-REFERENCE TO RELATED APPLICATIONS

This application is a continuation application of PCT Application Serial Number PCT/JP2021/039024, filed on Oct. 21, 2021. Further, this application claims priority from U.S. Provisional Application No. 63/094,973, filed on Oct. 22, 2020, U.S. Provisional Application No. 63/115,119, filed on Nov. 18, 2020, and Japanese Patent Application Number JP 2021-015793, filed on Feb. 3, 2021, the entire contents of which are hereby incorporated by reference into this application.

The present invention relates to a vehicle door, a vehicle, and a vehicle manufacturing method.

### Description of the Related Art

Known in the related art is a decorative component for a vehicle attached on the interior side of the vehicle, designed as a decorative component, and exhibiting a practical function.

For example, WO 2013/081070 A (“070 Document”) proposes, as an example of decorative components for vehicles, a vehicle door lining and a vehicle door functioning as decorative lighting and capable of harmonizing with surrounding members when the light is off from the viewpoint of design improvement.

### SUMMARY OF THE INVENTION

An object of the present invention is to provide a vehicle door having a reinforcement structure, a vehicle, and a vehicle manufacturing method.

The above object is achieved by means of a vehicle door provided in a vehicle and including a door panel serving as a base plate of the vehicle door, and a door lining attached to a vehicle inside of the door panel, in which the door panel has an inner panel disposed on the vehicle inside of the door panel and a reinforcement member attached to a side surface of the inner panel on a vehicle outside, formed so as to protrude to the vehicle outside, and having a U-shaped cross section, the door lining has an impact absorbing body formed so as to become narrow in a stepwise manner toward the inner panel, the reinforcement member has a panel attachment portion attached to the side surface of the inner panel on the vehicle outside, the panel attachment portion is disposed at a position overlapping an outside end portion of the impact absorbing body on the vehicle outside in an up to down direction, and a middle portion of the reinforcement member in the up to down direction is disposed at a position below an upper end of the outside end portion of the impact absorbing body.

With the above configuration, a vehicle door having a reinforcement structure can be realized.

In addition, the above object is also achieved by means of a vehicle having a reinforcement structure and a vehicle manufacturing method.

### BRIEF DESCRIPTION OF THE DRAWINGS

FIG. 1 is a longitudinal sectional view of a vehicle illustrating the configuration of a vehicle door.

FIG. 2 is a side view in which a vehicle door lining of a first embodiment is viewed from the vehicle inside.

FIG. 3 is a side view of the vehicle door lining illustrating the disposition of a power generation member, a light-emitting member, and a power storage member.

FIG. 4 is a longitudinal sectional view of the vehicle door lining illustrating the power generation member, the light-emitting member, and the power storage member.

FIG. 5 is a diagram describing the structure of the power generation member (solar battery module).

FIG. 6 is a block diagram describing an electric circuit for the lighting function of the vehicle door lining.

FIG. 7 is a sectional view of a vehicle door lining of a second embodiment.

FIG. 8A is a side view of a vehicle door lining of a third embodiment.

FIG. 8B is a side view of a vehicle door lining of a fourth embodiment.

FIG. 8C is a side view of a vehicle door lining of a fifth embodiment.

FIG. 8D is a side view of a vehicle door lining of a sixth embodiment.

FIG. 8E is a side view of a vehicle door lining of a seventh embodiment.

FIG. 8F is a side view of a vehicle door lining of an eighth embodiment.

FIG. 9 is a perspective view of a vehicle seat of a first embodiment.

FIG. 10 is a perspective view of a seat frame serving as a skeleton.

FIG. 11 is a schematic diagram illustrating a lumbar support, a movable body, and an operating device.

FIG. 12A is a cross-sectional view of a seat back describing a state where the side portion of the seat back is at “normal position”.

FIG. 12B is a diagram illustrating a state where the side portion is at “protruding position”.

FIG. 13 is a perspective view of a vehicle seat of a second embodiment.

FIG. 14A is a plan view of a seat cushion describing the position of a blower device.

FIG. 14B is a diagram illustrating Modification Example 1 of the seat cushion.

FIG. 15 is a perspective view of a vehicle seat of a third embodiment.

FIG. 16 is a perspective view of a seat frame describing the positions of a blower device and a seating sensor.

FIG. 17A is a longitudinal sectional view of a seat cushion describing the position of the seating sensor.

FIG. 17B is a longitudinal sectional view of the seat cushion describing the position of the blower device (duct).

FIG. 17C is a diagram illustrating Modification Example 2 of the seat cushion and is a diagram describing the position of the seating sensor.

FIG. 17D is a diagram illustrating Modification Example 2 of the seat cushion and is a diagram describing the position of the duct.

FIG. 18 is a perspective view of a vehicle seat of a fourth embodiment.

FIG. 19 is a plan view of a seat cushion describing the positions of a duct and a ventilation hole.

FIG. 20 is a longitudinal sectional view of the seat cushion.

FIG. 21 is a perspective view of a vehicle seat of a fifth embodiment.

FIG. 22 is a longitudinal sectional view of a seat cushion describing a seating sensor.

FIG. 23 is a perspective view of a vehicle seat of a sixth embodiment.

FIG. 24 is a plan view of a seat cushion describing an adhesion region and a second adhesion region.

FIG. 25 is a cross-sectional view of the seat cushion.

FIG. 26 is a perspective view of a vehicle seat of a seventh embodiment.

FIG. 27 is a plan view of a seat cushion describing an adhesion region.

FIG. 28 is a perspective view of a vehicle seat of an eighth embodiment.

FIG. 29A is a plan view of a seat cushion describing a seat heater (thermostat).

FIG. 29B is a diagram describing Modification Example 3 of the seat cushion and is a diagram illustrating the thermostat.

FIG. 30 is a perspective view of a vehicle seat of a ninth embodiment.

FIG. 31A is a cross-sectional view of a seat back describing a side airbag device.

FIG. 31B is Modification Example 1 of the side airbag device.

FIG. 31C is Modification Example 2 of the side airbag device.

FIG. 31D is Modification Example 3 of the side airbag device.

FIG. 32 is a side view of a vehicle seat of a tenth embodiment.

FIG. 33 is a side view of the vehicle seat illustrating a state where an airbag is inflated.

FIG. 34 is a perspective view of a vehicle seat of an eleventh embodiment.

FIG. 35A is a cross-sectional view of a seat back describing a state where the side portion of the seat back is at “normal position”.

FIG. 35B is a diagram illustrating a state where the side portion is at “protruding position”.

FIG. 36 is a perspective view of a vehicle seat of a twelfth embodiment.

FIG. 37 is a longitudinal sectional view of a seat cushion describing a cushion length adjustment device.

FIG. 38 is a side view of a vehicle seat of a thirteenth embodiment describing the positions of a lumbar support and an adhesion portion.

FIG. 39 is Modification Example 1 of the seat back and is a diagram describing the positions of the lumbar support and the adhesion portion.

FIG. 40 is a perspective view of a vehicle seat of a fourteenth embodiment.

### DESCRIPTION OF THE PREFERRED EMBODIMENTS

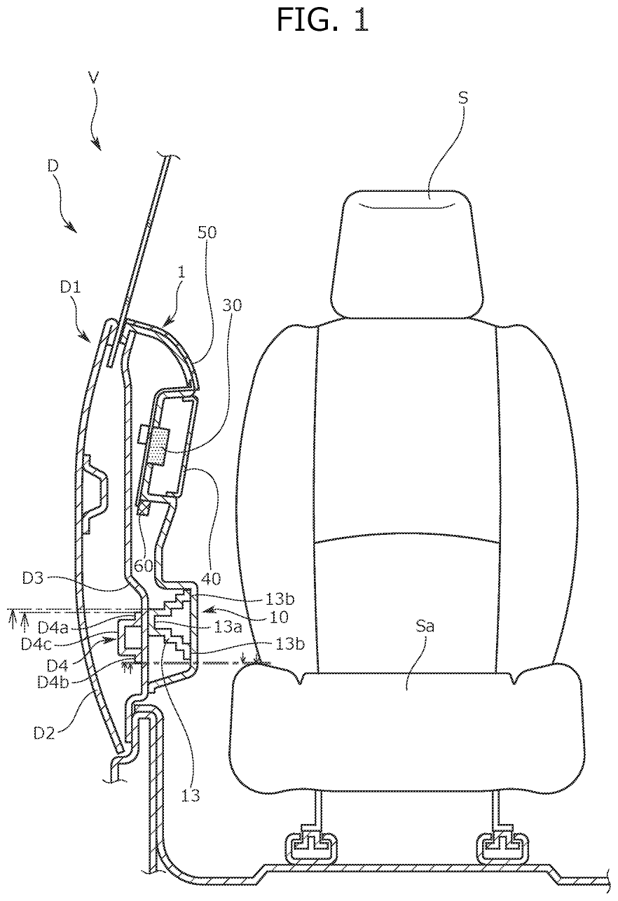

Description will be made below with reference to FIGS. 1 to 40.

The present embodiment relates to a vehicle door, a vehicle, and a vehicle manufacturing method.

It should be noted that “vehicle front to back direction (front to back direction)” means the front to back direction during the normal travel of the vehicle and “vehicle inside in vehicle width direction (width direction)” means the interior side of the vehicle with respect to the vehicle door.

<First Embodiment of Vehicle Door Lining>

First, a vehicle door lining 1 (hereinafter, also referred to as a door lining) of a first embodiment will be described with reference to FIGS. 1 to 8F.

As illustrated in FIG. 1, a vehicle V includes a vehicle door D of the vehicle V and a vehicle seat S provided in the vehicle V. The vehicle seat S has a seat cushion Sa.

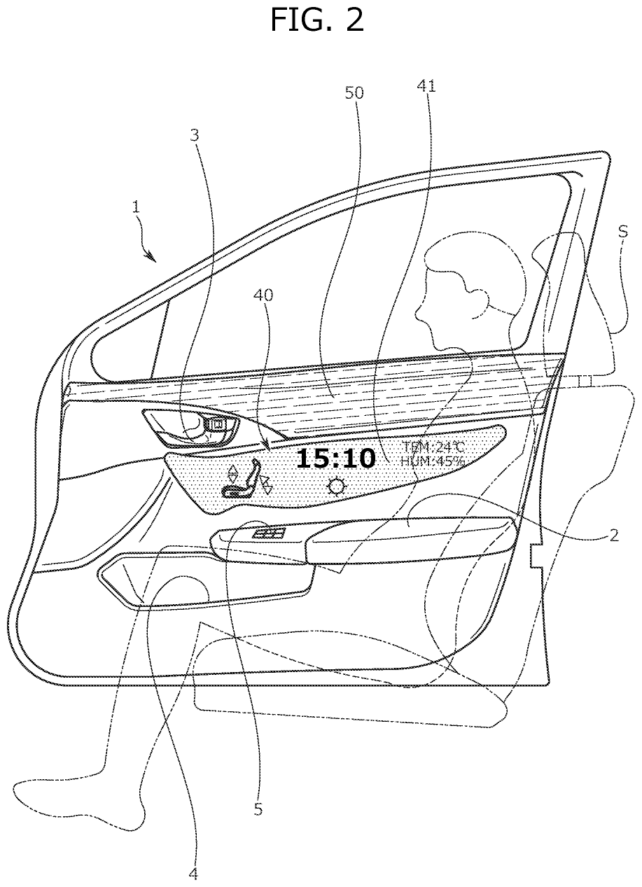

As illustrated in FIGS. 1 and 2, the vehicle door lining 1 is a vehicle interior component that decorates the vehicle inside of the vehicle door D and is configured by a group of components attached to a door panel D1 serving as the base plate of the vehicle door D.

For example, as illustrated in FIG. 2, the door lining 1 includes an armrest 2 supporting a seated occupant's arm, an operating handle 3 disposed at a position above the front part of the armrest 2 so that the vehicle door D is opened and closed, a pocket portion 4 disposed at a position below the front part of the armrest, and an operating panel 5 for power window opening and closing adjustment disposed on the upper surface of the armrest 2.

As illustrated in FIG. 1, the door panel D1 is configured mainly from an outer panel D2 formed from a steel plate and an inner panel D3 formed from a steel plate.

A reinforcement member D4 elongatedly extending in the seat front to back direction is formed on the inside surface of the inner panel D3. It should be noted that reinforcement members may be further formed on the inside surface of the outer panel D2 and the outside surface of the inner panel D3.

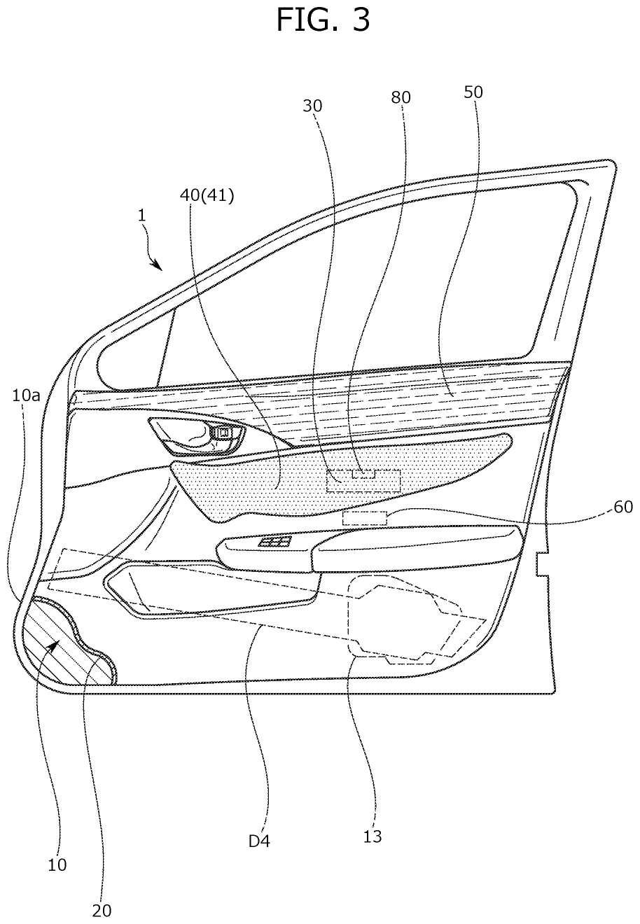

As illustrated in FIG. 1, the reinforcement member D4 has, for example, a groove-shaped longitudinal section and forms a closed sectional structure together with the main body portion of the inner panel D3. In addition, as illustrated in FIG. 3, the reinforcement member D4 extends, while being inclined downward, from the front end portion of the door lining 1 toward the rear end portion of the door lining 1.

As illustrated in FIG. 1, the reinforcement member D4 has an upper panel attachment portion D4a and a lower panel attachment portion D4b attached to the side surface of the inner panel D3 on the vehicle outside and a protruding end portion D4c protruding to the vehicle outside.

As illustrated in FIGS. 2 to 4, the door lining 1 is configured by covering a door lining base material 10 serving as the base plate of the door lining 1 with a skin material 20.

It should be noted that as for the door lining 1, the front end portion of the door lining base material 10 is rotatably attached to the vehicle body via a hinge 10a.

Therefore, connecting members for various electrical components provided on the door lining 1 extend toward the front end portion of the door lining 1. Further, the connecting members are connected to a power source (power source system) provided in the vehicle body.

The door lining 1 includes, as lighting modules for an in-vehicle lighting function, a light-emitting member 30 emitting light toward the inside of the vehicle, a decorative panel 40 irradiated by the light-emitting member 30, a power generation member 50 supplying electricity to the light-emitting member 30, a power storage member 60 storing electricity, and a connecting member 70 electrically connecting each of the light-emitting member 30, the decorative panel 40, the power generation member 50, and the power storage member 60.

Further, the door lining 1 includes a control controller 80 electrically connected to the light-emitting member 30, the decorative panel 40, the power generation member 50, and the power storage member 60 via the connecting member 70 and controlling the light emission of the light-emitting member 30.

The light-emitting member 30, the decorative panel 40, the power generation member 50, the power storage member 60, and the control controller 80 are respectively attached at predetermined positions of the door lining base material 10.

As illustrated in FIGS. 1, 3, and 4, the door lining base material 10 is a plate-shaped frame made of resin and extends so as to be elongated in the vehicle front to back direction.

The door lining base material 10 includes an armrest base material portion 11 formed on the side surface of the door lining base material 10 on the vehicle inside and serving as the base material portion of the armrest 2, an assembly portion 12 formed at a position above the armrest base material portion 11 so that the light-emitting member 30 and the decorative panel 40 are assembled, and an impact absorbing portion 13 formed on the side surface of the door lining base material 10 on the vehicle outside, disposed at a position below the armrest base material portion 11, and protruding toward the door panel D1.

The assembly portion 12 is formed as a substantially rectangular recess. The light-emitting member 30 is attached to the bottom portion of the assembly portion 12. In addition, the decorative panel 40 is fitted in the opening portion of the assembly portion 12.

The impact absorbing portion 13 is an impact absorbing body provided between the door panel D1 and the door lining 1 in order to mitigate the impact that is applied from the vehicle door D to the seated occupant in the event of a side collision of the vehicle.

Specifically, the impact absorbing portion 13 is formed as a substantially circular protrusion and is formed so as to become narrow in stages from the door lining 1 toward the door panel D1. In other words, the impact absorbing portion 13 is formed so as to protrude in a stepwise manner.

With the above configuration, the load that is applied in the event of a collision can be suppressed by deformation appropriately occurring in accordance with the amount of displacement (deformation) of the vehicle door D.

As illustrated in FIG. 1, the impact absorbing portion 13 has an outside end portion 13a at the end portion of the impact absorbing portion 13 on the vehicle outside and an inside end portion 13b at the end portion of the impact absorbing portion 13 on the vehicle inside.

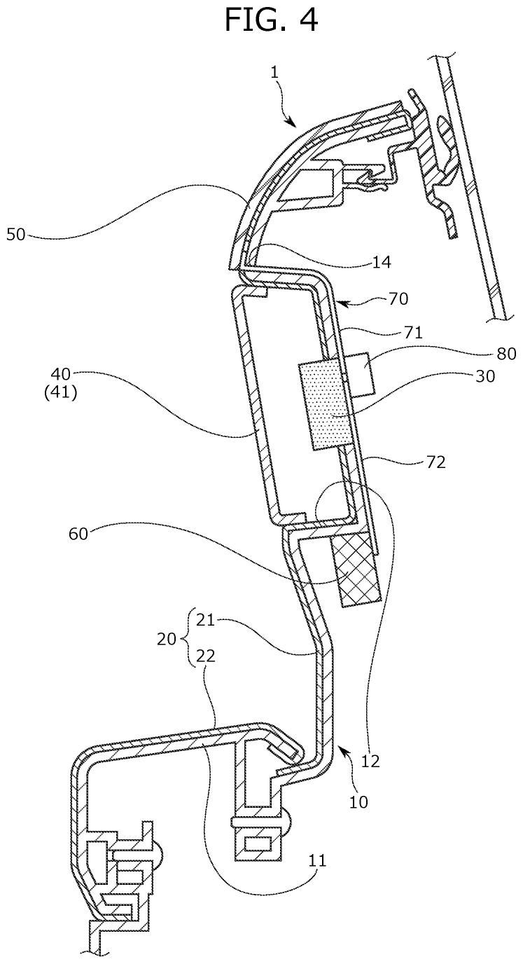

As illustrated in FIGS. 3 and 4, the skin material 20 is made of a resin material (for example, TP0), fabric (for example, PET material), genuine leather, or the like and is formed in a shape in which the surface of the door lining base material 10 on the vehicle inside can be covered.

Specifically, the skin material 20 has a first skin material 21 that covers the part above the armrest base material portion 11 on the surface of the door lining base material 10 on the vehicle inside and a second skin material 22 that covers the part below the armrest base material portion 11.

The skin end portion of the first skin material 21 and the skin end portion of the second skin material 22 are attached to skin attachment portions provided on the door lining base material 10.

It should be noted that the door lining 1 may not have the skin material 20.

As illustrated in FIGS. 3 and 4, the light-emitting member 30 is a planar light-emitting body that is elongated in the seat front to back direction.

As illustrated in FIGS. 2 to 4, the decorative panel 40 is a light-transmitting planar resin member that is exposed to the vehicle inside and has a decorative lighting function.

As illustrated in FIGS. 2 to 5, the power generation member 50 is a film-shaped solar battery module, is attached to the upper part (upper end part) of the door lining 1, and is disposed along the surface of the door lining 1 on the vehicle inside.

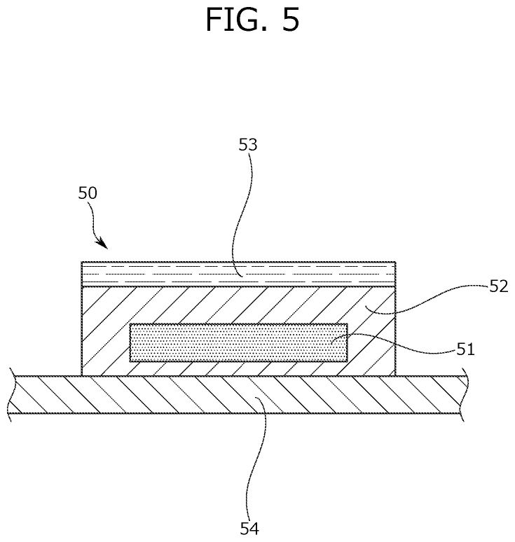

Specifically, the power generation member 50 is an organic thin film-type solar battery module. As illustrated in FIG. 5, the power generation member 50 is configured mainly from a power generation body that has a solar battery cell 51, a sealing layer 52 sealing the solar battery cell 51, and a surface layer 53 provided closer to the surface side of the power generation member 50 than the sealing layer 52 and a film substrate 54 that is made of resin and serves as the base plate of the power generation body.

As illustrated in FIGS. 3 and 4, the power storage member 60 is a plate-shaped storage battery, stores the electricity generated by the power generation member 50, and supplies the electricity toward the light-emitting member 30.

As illustrated in FIG. 4, the connecting member 70 has a first connecting member 71 that connects the light-emitting member 30, the power generation member 50, and the control controller 80 and a second connecting member 72 that connects the light-emitting member 30, the power storage member 60, and the control controller 80.

One end portion of the first connecting member 71 passes through a through hole 14 provided in the door lining base material 10 and is electrically connected to the lower end portion of the power generation member 50.

In addition, the other end portion of the first connecting member 71 is connected to the light-emitting member 30 and the control controller 80 in a state of being sandwiched between the light-emitting member 30 and the control controller 80.

One end portion of the second connecting member 72 is sandwiched and connected between the light-emitting member 30 and the control controller 80.

In addition, the other end portion of the second connecting member 72 is connected to the upper end portion of the power storage member 60.

In the above configuration, as illustrated in FIG. 4, the connecting member 70 is configured from a film-shaped electric circuit, and thus disposition can be more compact than in the case of existing harnesses. In addition, the weight of the door lining 1 can be reduced.

As illustrated in FIGS. 3 and 4, the control controller 80 is a control device that performs comprehensive electric control on the lighting function of the door lining 1 and is attached to the back surface of the light-emitting member 30.

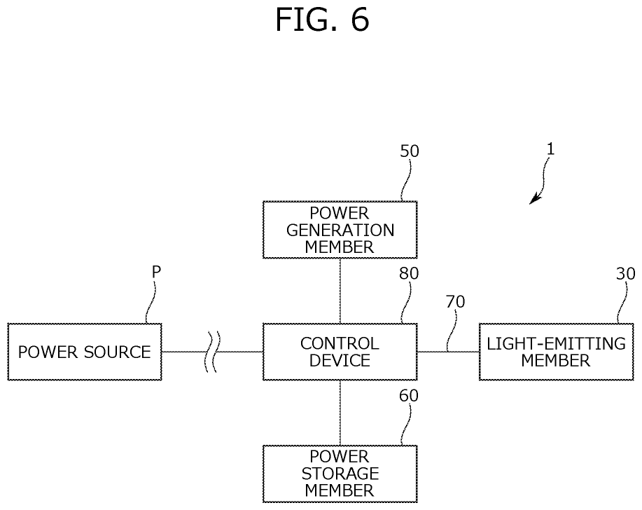

As illustrated in FIG. 6, the control controller 80 is connected to the light-emitting member 30 (decorative panel 40), the power generation member 50, and the power storage member 60. Based on the seated occupant inputting of a predetermined user operation, the control controller 80 controls electricity supply from the power generation member 50 or the power storage member 60 to the light-emitting member 30 and the decorative panel 40.

By doing so, a predetermined decorative pattern can be displayed in a light-emitting region 41 of the decorative panel 40.

In addition, as illustrated in FIG. 6, the control controller 80 is electrically connected to a power source P (for example, in-vehicle battery) provided in the vehicle body via a connecting member (not illustrated). The control controller 80 performs electric control on the door lining 1 during delivery for electricity supply between the control controller 80 and the power source P.

With the above configuration, it is possible to realize the door lining 1 that is capable of exhibiting an in-vehicle lighting function even if no electricity is supplied from the power source P of the vehicle body.

### Second Embodiment

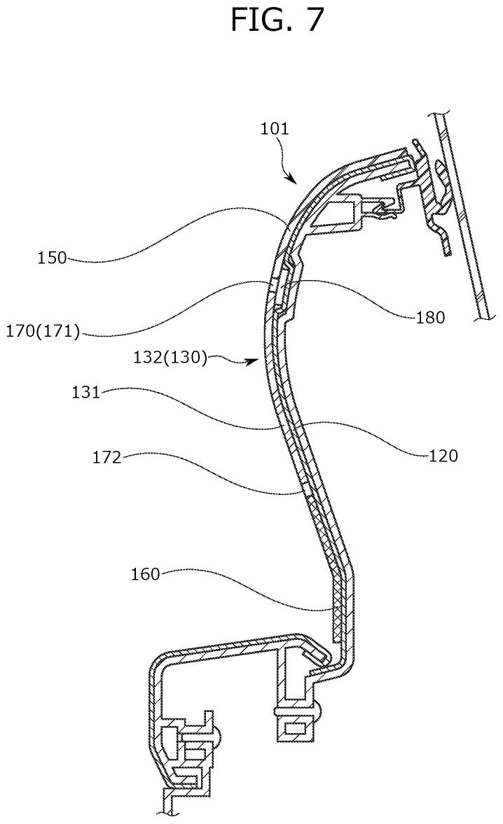

Next, a door lining 101 of a second embodiment will be described with reference to FIG. 7.

It should be noted that description of content that overlaps with the door lining 1 described above will be omitted.

The door lining 101 differs from the door lining 1 mainly in the configuration of the component for exhibiting the lighting function.

The door lining 101 includes, as lighting modules for an in-vehicle lighting function, a light-emitting member 130 having a light-emitting region 132, a power generation member 150, a power storage member 160, a connecting member 170, and a control controller 180.

Further, the light-emitting member 130, the power generation member 150, the power storage member 160, and the connecting member 170 are integrally formed in a film shape and are integrally attached to the surface of a skin material 120 of the door lining 101.

The light-emitting member 130 is a film-shaped light-emitting body and is formed by printing an inorganic compound (for example, zinc sulfide) on a conductive film substrate 131 (for example, PET film substrate). Further, the surface of the light-emitting member 130 is formed as the light-emitting region 132.

The power generation member 150 is a film-shaped solar battery module and is formed by stacking a solar battery cell-including stacked body on the film substrate 131.

The power storage member 160 is a film-shaped storage battery (for example, film-type lithium-ion secondary battery) and is formed by applying a gel- or jelly-shaped electrolyte material onto the film substrate 131.

The connecting member 170 is a film-shaped electric circuit, and the electric circuit is configured by providing metal wiring on the film substrate 131.

The connecting member 170 has a first connecting member 171 that connects the light-emitting member 130, the power generation member 150, and the control controller 180 and a second connecting member 172 that connects the light-emitting member 130 and the power storage member 160.

With the above configuration as well, it is possible to realize the door lining that is capable of exhibiting an in-vehicle lighting function even if no electricity is supplied from the power source of the vehicle body.

<Third to Eighth Embodiments>

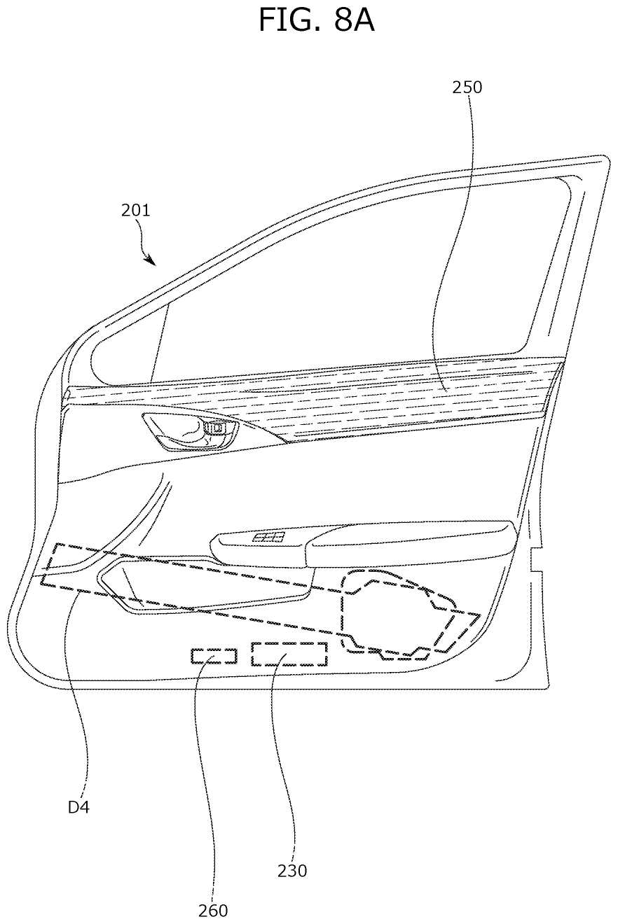

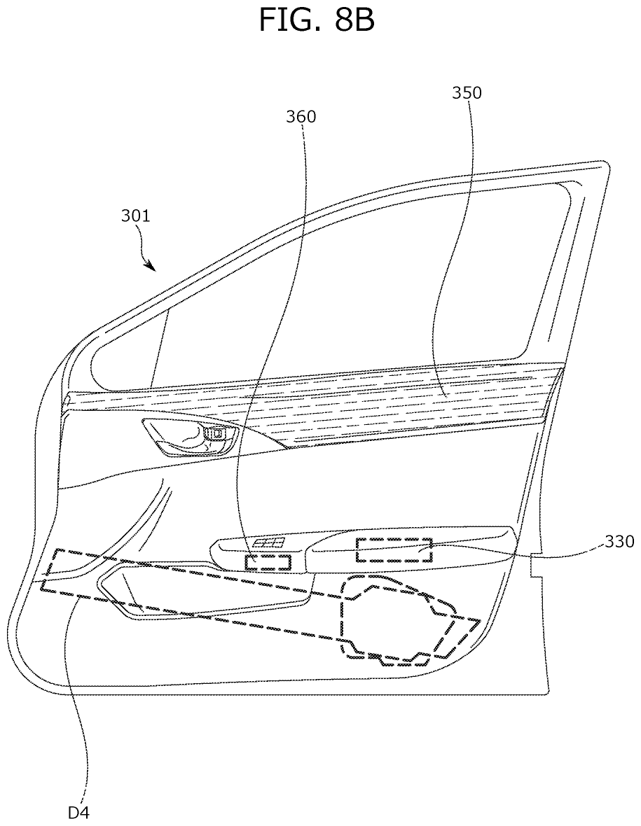

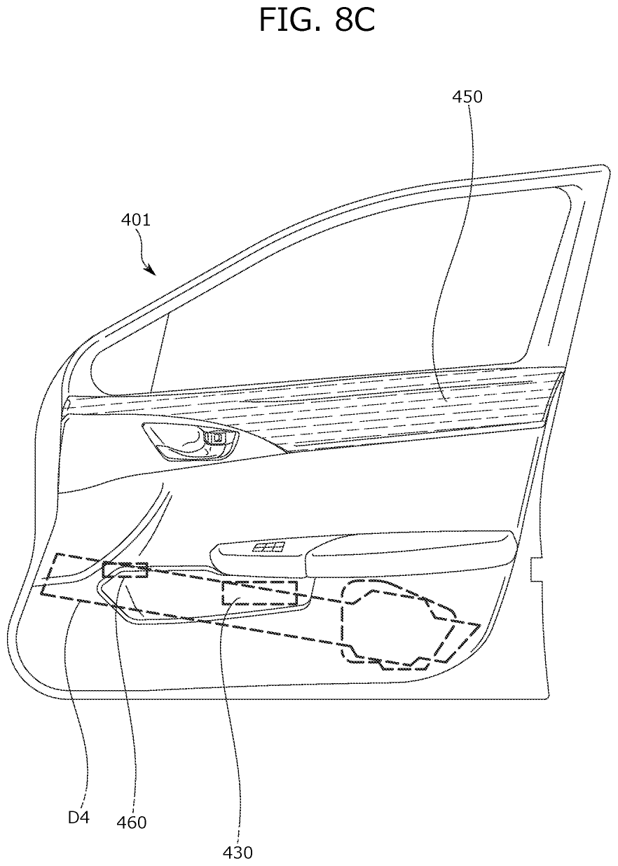

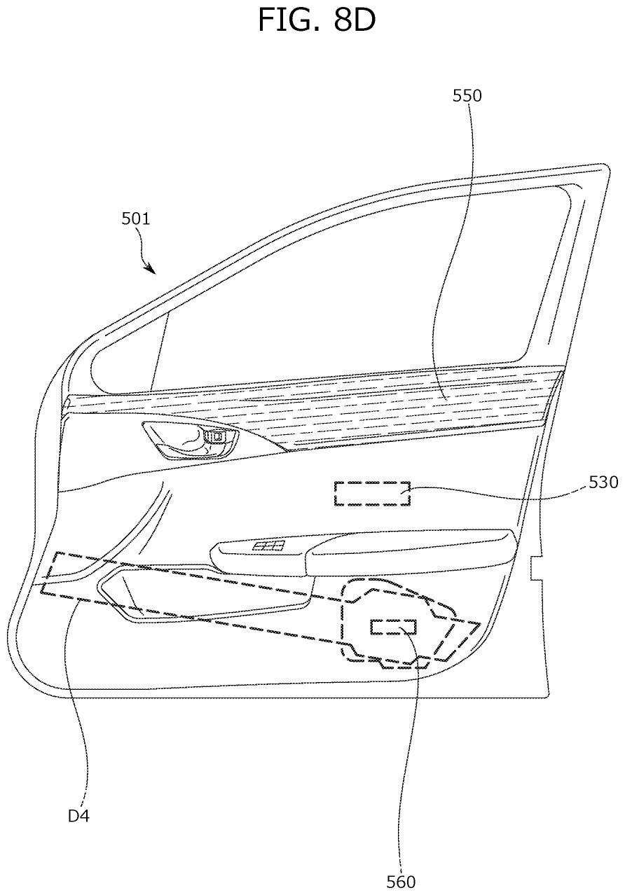

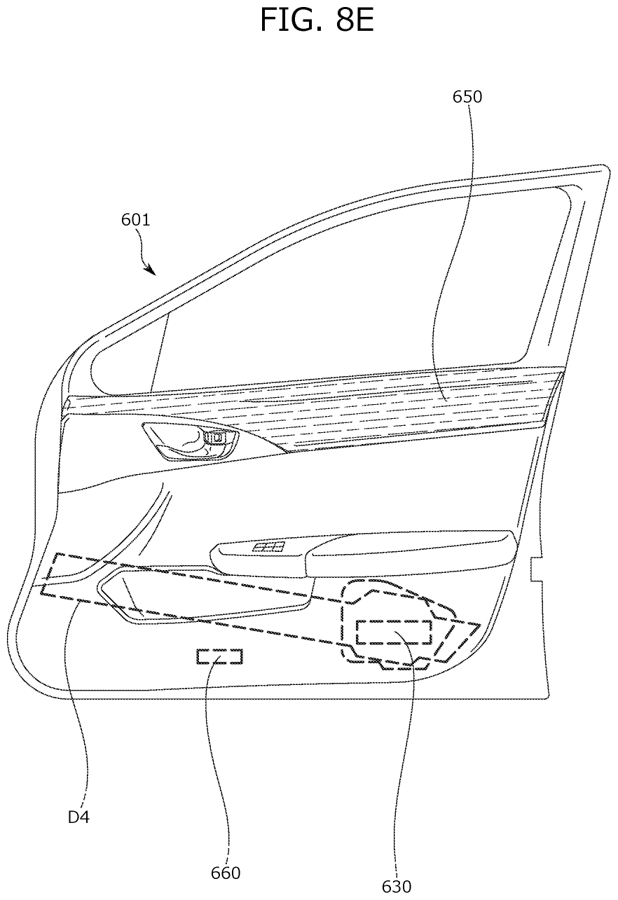

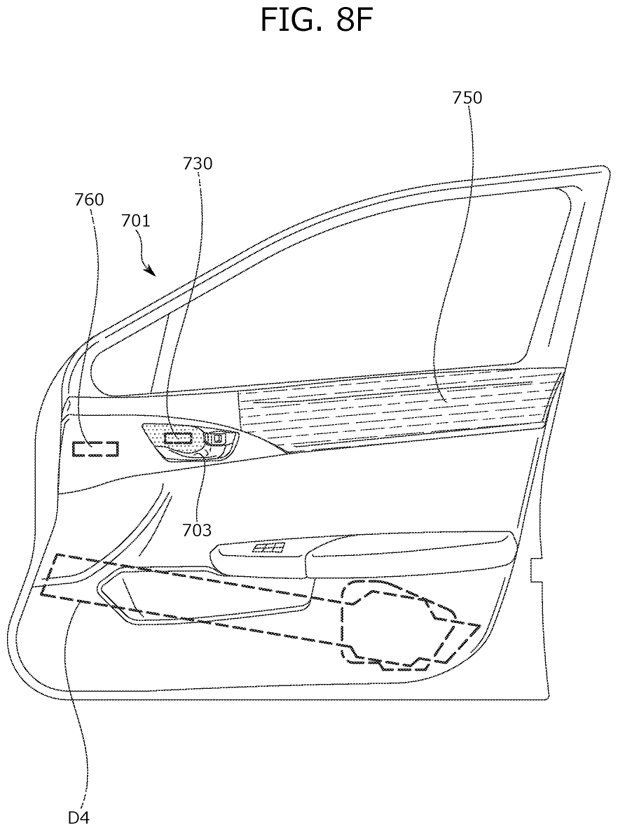

Next, door linings 201, 301, 401, 501, 601, and 701 of third to eighth embodiments will be described with reference to FIGS. 8A to 8F.

The door linings of the third to eighth embodiments differ from the door lining 1 in the disposition of light-emitting members and power storage members.

It should be noted that decorative panels, connecting members, and control controllers are neither illustrated nor described.

As illustrated in FIG. 8A, the door lining 201 of the third embodiment includes a light-emitting member 230, a power generation member 250, and a power storage member 260 as lighting modules.

As illustrated in FIG. 8B, the door lining 301 of the fourth embodiment includes a light-emitting member 330, a power generation member 350, and a power storage member 360 as lighting modules.

As illustrated in FIG. 8C, the door lining 401 of the fifth embodiment includes a light-emitting member 430, a power generation member 450, and a power storage member 460 as lighting modules.

As illustrated in FIG. 8D, the door lining 501 of the sixth embodiment includes a light-emitting member 530, a power generation member 550, and a power storage member 560 as lighting modules.

As illustrated in FIG. 8E, the door lining 601 of the seventh embodiment includes a light-emitting member 630, a power generation member 650, and a power storage member 660 as lighting modules.

As illustrated in FIG. 8F, the door lining 701 of the eighth embodiment includes a light-emitting member 730, a power generation member 750, and a power storage member 760 as lighting modules.

With the above configuration as well, it is possible to realize the door lining that is capable of exhibiting an in-vehicle lighting function even if no electricity is supplied from the power source of the vehicle body.

In addition, with the above disposition of the light-emitting member 730, the power generation member 750, and the power storage member 760, effects on the light-emitting member 730, the power generation member 750, and the power storage member 760 can be mitigated even in a case where an impact load is applied to the vehicle door D in the event of a side collision of the vehicle.

In addition, with the above disposition of the light-emitting member 730 and the power storage member 760, the light-emitting member 730 and the power storage member 760 are disposed close to the front end portion of the vehicle door D and close to the power source (power source system) provided in the vehicle body.

By doing so, electricity from the vehicle body power source can be efficiently supplied to the lighting module and electricity loss can be minimized.

<First Embodiment of Vehicle Seat>

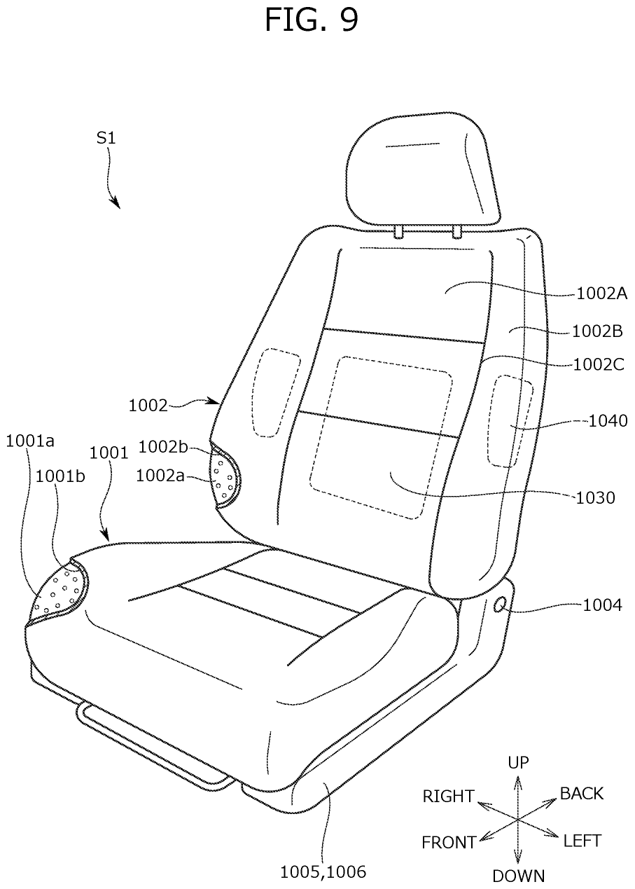

Next, a vehicle seat S1 of a first embodiment will be described with reference to FIGS. 9 to 12A and 12B.

The vehicle seat S1 realizes a seat capable of efficiently receiving the load that is applied from the occupant to the seat back in the event of a rear collision of the vehicle.

Specifically, the vehicle seat S1 is provided with a seat back configured by skin material adhesion to a pad material and realizes the seat capable of efficiently receiving the load that is applied from the occupant to the seat back in the event of a rear collision of the vehicle.

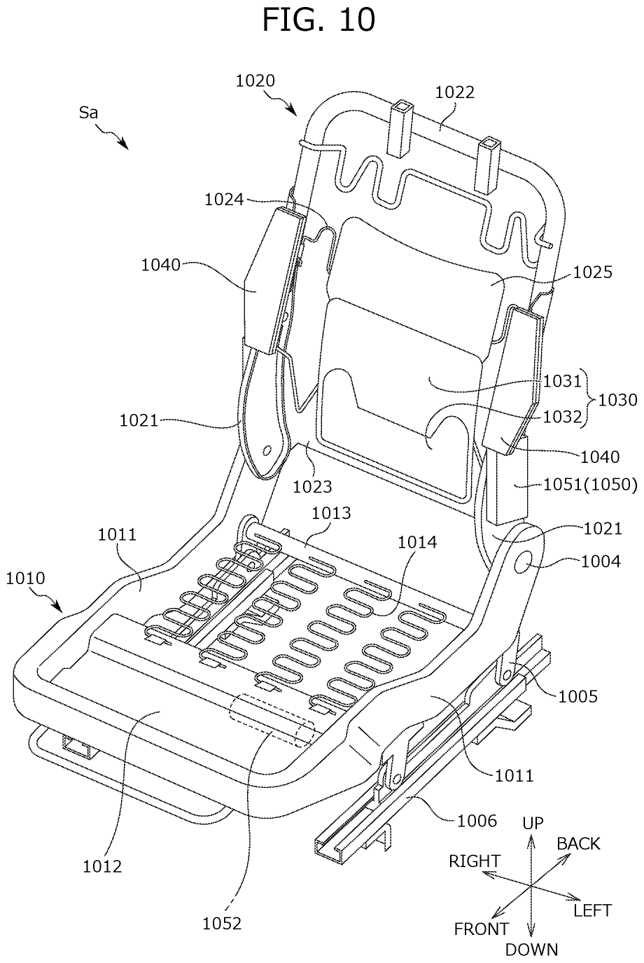

As illustrated in FIGS. 9 and 10, the vehicle seat S1 includes a seat main body having a seat cushion 1001 and a seat back 1002, a lumbar support 1030 attached in the seat back 1002 and movable for a middle portion 1002A of the seat back 1002 to protrude to the seated occupant side as compared with the normal position, a movable body 1040 (side support member) attached in the seat main body and movable for a side portion 1002B of the seat back 1002 to protrude to the seated occupant side as compared with the normal position, and an operating device 1050 (fluid supply device) operating so that the lumbar support 1030 and the movable body 1040 can be moved.

As illustrated in FIG. 9, the seat cushion 1001 is a seating portion that supports the seated occupant from below and is configured by placing a pad material 1001a on a cushion frame 1010, which is illustrated in FIG. 10 and serves as a skeleton, and by being covered with a skin material 1001b.

As illustrated in FIG. 9, the seat back 1002 is a backrest portion that supports the seated occupant's back from behind and is configured by placing a pad material 1002a on a back frame 1020, which is illustrated in FIG. 10 and serves as a skeleton, and by being covered with a skin material 1002b.

The seat back 1002 is configured from the middle portion 1002A at the middle part in the seat width direction and the right and left side portions 1002B (side bolster portions) on the outer sides of the middle portion 1002A in the seat width direction.

Right and left pull-in grooves 1002C are formed on the surface of the pad material 1002a and extend in the up to down direction so as to distinguish the middle portion 1002A from the right and left side portions 1002B.

As illustrated in FIG. 10, the cushion frame 1010 as a rectangular frame-shaped body is configured mainly from side frames 1011 disposed on the right and left sides, a plate-shaped pan frame 1012 (bridging frame) bridged between the front end parts of the side frames 1011, a rear connecting frame 1013 connecting the rear parts of the side frames 1011, and a plurality of support members 1014 (elastic springs) respectively hooked to the pan frame 1012 and the rear connecting frame 1013 and extending in the seat front to back direction.

The side frame 1011 is a plate-shaped frame that is elongated in the seat front to back direction.

It should be noted that a reclining device 1004 is attached to the rear part of the side frame 1011 and a rail device 1006 is attached to the lower part thereof via a height link device 1005.

As illustrated in FIG. 10, the back frame 1020 as a rectangular frame-shaped body is configured mainly from back side frames 1021 disposed on the right and left sides, an inverted U-shaped upper frame 1022 connecting the upper end parts of the back side frames 1021, a plate-shaped lower frame 1023 connecting the lower end parts of the back side frames 1021, a plurality of wire members 1024 (elastic wires) respectively hooked to the back side frames 1021 and extending in a serpentine shape in the seat width direction, and a support plate 1025 held by the plurality of wire members 1024 and supporting the seated occupant.

The back side frame 1021 is a sheet metal member that extends in the up to down direction and has a substantially C-shaped cross section. The lower end part of the back side frame 1021 is connected to the rear end part of the side frame 1011 via the reclining device 1004.

In the above configuration, the back frame 1020 is capable of pivoting relative to the cushion frame 1010.

In the above configuration, the lumbar support 1030 is attached to the front surface of the lower part of the support plate 1025 as illustrated in FIG. 10.

In addition, as illustrated in FIG. 10, the right and left movable bodies 1040 are attached to the front surfaces of the lower parts of the right and left back side frames 1021.

As illustrated in FIGS. 10 to 12A and 12B, the lumbar support 1030 has a bag body (air cell) that inflates by a fluid being enclosed, inflates to the seated occupant side (protrudes from the normal position to the protruding position) by compressed air as a fluid being enclosed, and contracts (returns to the normal position) by the enclosed compressed air being discharged.

Specifically, the lumbar support 1030 is a member that supports the seated occupant's lumbar and is disposed between the pad material 1002a and the support plate 1025 in the middle portion 1002A at the lower part of the seat back 1002. Further, the lumbar support 1030 is a member that is movable for the middle portion 1002A (pad material 1002a) to protrude to the seated occupant side.

The lumbar support 1030 is attached to the front surface of the support plate 1025 in a folded state.

The lumbar support 1030 has a rectangular shape that is elongated in the seat width direction and is configured mainly from a base member 1031 (base plate) supported by the support plate 1025 and a bag body 1032 supported on the front surface of the base member 1031.

The bag body 1032 is capable of inflating to the seat front side by compressed air being enclosed in a folded state.

As illustrated in FIGS. 10 to 12A and 12B, the movable body 1040 has a bag body (air cell), inflates to the seated occupant side (protrudes from the normal position to the protruding position) by compressed air being enclosed, and contracts (returns to the normal position) by the enclosed compressed air being discharged.

Specifically, the movable body 1040 is a side support member that supports the seated occupant from a side and is disposed between the pad material 1002a and the back side frame 1021 in the side portion 1002B at the lower part of the seat back 1002. Further, the movable body 1040 is a member that is movable for the side portion 1002B (pad material 1002a) to protrude to the seated occupant side (seat front side and inside in the seat width direction).

The movable body 1040 is attached to the front surface of the back side frame 1021 in a folded state.

The movable body 1040 has a substantially pentagonal shape that is elongated in the up to down direction and is configured mainly from a base member 1041 supported by the back side frame 1021, a pivoting member 1043 disposed at a position in front of the base member 1041 in the seat and attached so as to be pivotable via a pivot shaft 1042 with respect to the base member 1041, and a bag body 1044 disposed between the base member 1041 and the pivoting member 1043 and supported on the front surface of the base member 1041.

The base member 1041 is attached to the front surface of the back side frame 1021 and extends along the front surface of the back side frame so as to protrude in the seat width direction.

The pivot shaft 1042 is attached to the inside end portion of the front surface of the base member 1041 in the seat width direction.

The pivoting member 1043 is attached so as to be pivotable in the seat front to back direction with respect to the base member 1041. By the pivoting member 1043 pivoting toward the seat front, the side portion 1002B of the seat back 1002 is capable of protruding (can be pushed out) to the seat front side.

It should be noted that when the seat back 1002 is at the normal position, the pivoting member 1043 is disposed at a position close to the base member 1041 side. The pivoting member 1043 may be in a state of being biased to the base member 1041 side by a biasing spring (biasing member) (not illustrated).

The bag body 1044 is supported by the base member 1041. By compressed air being enclosed, the bag body 1044 inflates to the seat front side to be capable of pushing out the pivoting member 1043 toward the seat front. In other words, the pivoting member 1043 can be pivoted to the seat front.

With the above configuration, the direction and amount of protrusion of the seat back 1002 (side portion 1002B) can be adjusted by inflating the bag body 1044.

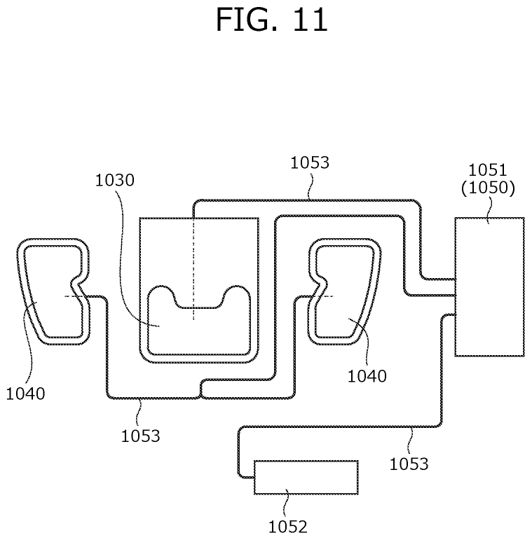

As illustrated in FIGS. 10 and 11, the operating device 1050 is a fluid supply device that is attached in the seat main body so that compressed air is supplied to the lumbar support 1030 (bag body 1032) and the movable body 1040 (bag body 1044).

The operating device 1050 is configured mainly from an air control unit 1051 attached to the outside surface of the back side frame 1021, an air pump 1052 attached to the back surface of the cushion frame 1010 (pan frame 1012) for compressed air supply (air supply) and compressed air discharge (air discharge), and an air pipe 1053 connecting the air pump 1052 and the lumbar support 1030 (movable body 1040).

The air control unit 1051 receives a predetermined control signal in response to, for example, the seated occupant selecting a predetermined user operation and controls the air pump 1052 such that compressed air is supplied to or discharged from the bag bodies 1032 and 1044.

By doing so, the ranges in which the lumbar support 1030 and the movable body 1040 are movable can be adjusted in accordance with the seated occupant's physique.

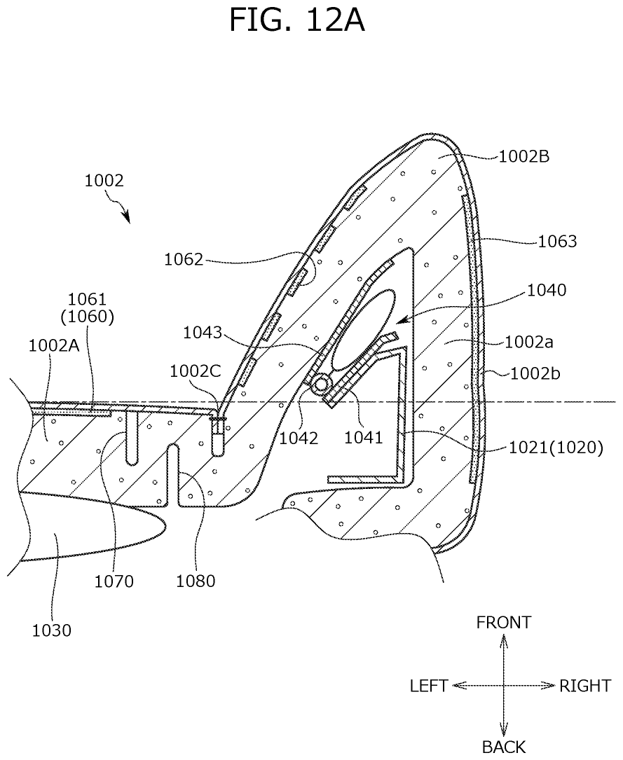

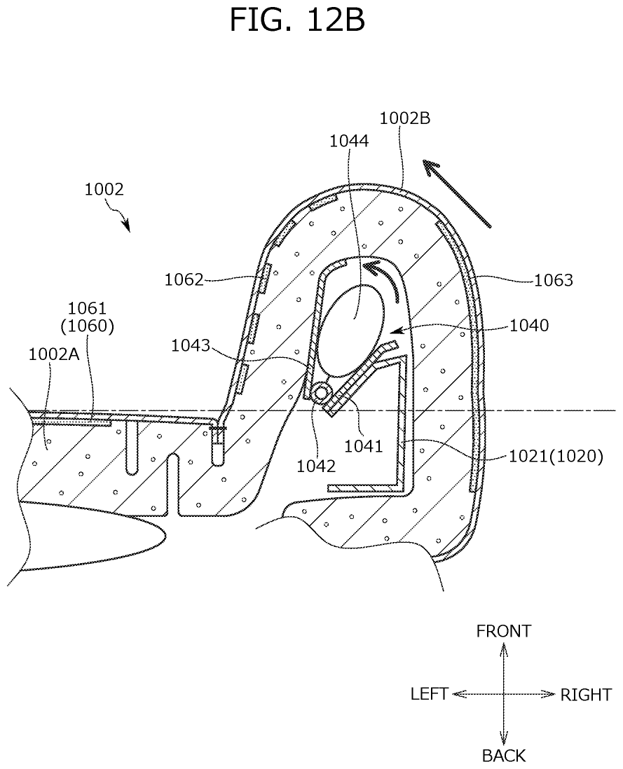

In the above configuration, as illustrated in FIG. 12A, when the middle portion 1002A of the seat back 1002 protrudes to the maximum to the seat front side by the lumbar support 1030, the rear end portion of the movable body 1040 is disposed closer to the seat front side than the seating surface of the middle portion 1002A of the seat back 1002.

In other words, the plurality of bag bodies 1044 are disposed closer to the seat front side than the seating surface of the middle portion 1002A of the seat back 1002.

Therefore, wrinkling and loosening of the skin material 1002b of the seat back 1002 can be suppressed.

Next, the operation of the movable body 1040 will be described in detail with reference to FIGS. 12A and 12B.

The movable body 1040 is capable of being movable so that the side portion 1002B of the seat back 1002 is moved from “normal position” illustrated in FIG. 12A to “protruding position” illustrated in FIG. 12B.

FIG. 12A is a diagram illustrating a state where the side portion 1002B of the seat back 1002 is at “normal position”.

FIG. 12B is a diagram illustrating a state where the side portion 1002B has moved from “normal position” to “protruding position” by the movable body 1040 protruding to the seat front.

Specifically, by compressed air being supplied from the operating device 1050, the bag body 1044 that is folded is inflation-deployed to the seat front and pushes out the pivoting member 1043 toward the seat front to move the side portion 1002B to the seat front. As a result, the side portion 1002B moves to “protruding position”.

It should be noted that by the compressed air in the bag body 1044 being discharged by the operating device 1050, the bag body 1044 that has inflated contracts and the side portion 1002B descends to the seat rear. As a result, the side portion 1002B returns from “protruding position” to “normal position”.

In addition to the above configuration, as illustrated in FIG. 12A, the pad material 1002a and the skin material 1002b are bonded by an adhesion portion 1060.

The adhesion portion 1060 is a part provided with an adhesive and is applied to the surface of the pad material 1002a continuously or at a predetermined interval along the up to down direction and the seat width direction.

The adhesion portion 1060 has a middle adhesion portion 1061 disposed in the middle portion 1002A of the seat back 1002 and first side adhesion portions 1062 and a second side adhesion portion 1063 disposed in the side portion 1002B.

The middle adhesion portion 1061 is disposed at a position overlapping the lumbar support 1030 in the seat width direction and the up to down direction.

In addition, the middle adhesion portion 1061 is disposed inside the right and left pull-in grooves 1002C in the seat width direction.

Specifically, the middle adhesion portion 1061 is disposed inside right and left surface weak portions 1070 formed on the surface of the pad material 1002a in the seat width direction and is disposed inside right and left back surface weak portions 1080 formed on the back surface of the pad material 1002a.

The first side adhesion portion 1062 is disposed at a position overlapping the movable body 1040 in the seat width direction and the up to down direction.

The plurality of first side adhesion portions 1062 are disposed at predetermined intervals in the seat width direction and the up to down direction.

It should be noted that the first side adhesion portion 1062 is disposed so as to avoid the part of the side portion 1002B that is easily deformed by the movable body 1040 being movable (specifically, most easily deformed part).

For example, the most easily deformed part of the side portion 1002B corresponds to the front end part of the side portion 1002B.

By partially forming “non-adhesion region” in this manner, the side portion 1002B is capable of smooth movement when the movable body 1040 is movable (see FIG. 12B).

The second side adhesion portion 1063 is disposed at a position overlapping the movable body 1040 in the seat front to back direction and the up to down direction.

The second side adhesion portion 1063 is disposed continuously in the seat front to back direction and the up to down direction.

By forming “adhesion region” in this manner, the pad material 1002a and the skin material 1002b can be suitably bonded in the side portion 1002B.

The surface weak portion 1070 is a groove on the surface of the pad material 1002a and is formed at a position that is inside the pull-in groove 1002C and adjacent to the pull-in groove 1002C.

The back surface weak portion 1080 is a groove on the back surface of the pad material 1002a and is formed at a position that is inside the pull-in groove 1002C and adjacent to the pull-in groove 1002C.

The back surface weak portion 1080 is disposed between the surface weak portion 1070 and the pull-in groove 1002C in the seat width direction.

It should be noted that although the surface weak portion 1070 and the back surface weak portion 1080 are grooves (recesses) formed continuously along the up to down direction, the surface weak portion 1070 and the back surface weak portion 1080 are not particularly limited and may be grooves (through grooves) formed at a predetermined interval along the up to down direction.

By the seat back 1002 being provided with the adhesion portion 1060 as described above, the pad material 1002a and the skin material 1002b can be bonded suitably.

In addition, by “non-adhesion region”, the surface weak portion 1070, and the back surface weak portion 1080 being formed in the seat back 1002, it is possible to realize the vehicle seat capable of efficiently receiving the load that is applied from the occupant to the seat back 1002 in the event of a rear collision of the vehicle.

Specifically, the support plate 1025 is capable of efficiently receiving the load that is applied from the occupant to the seat back 1002 in the event of a rear collision of the vehicle.

### Second Embodiment

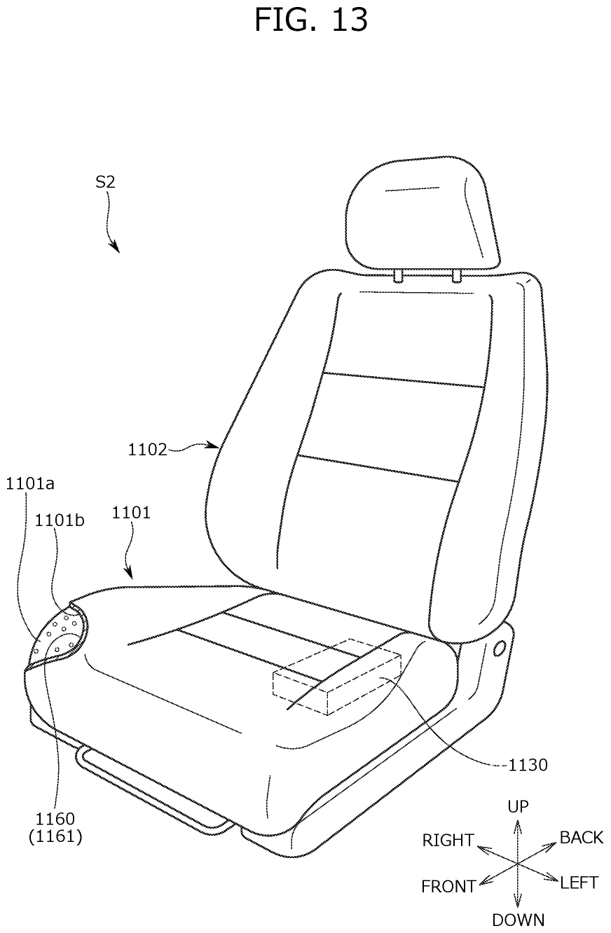

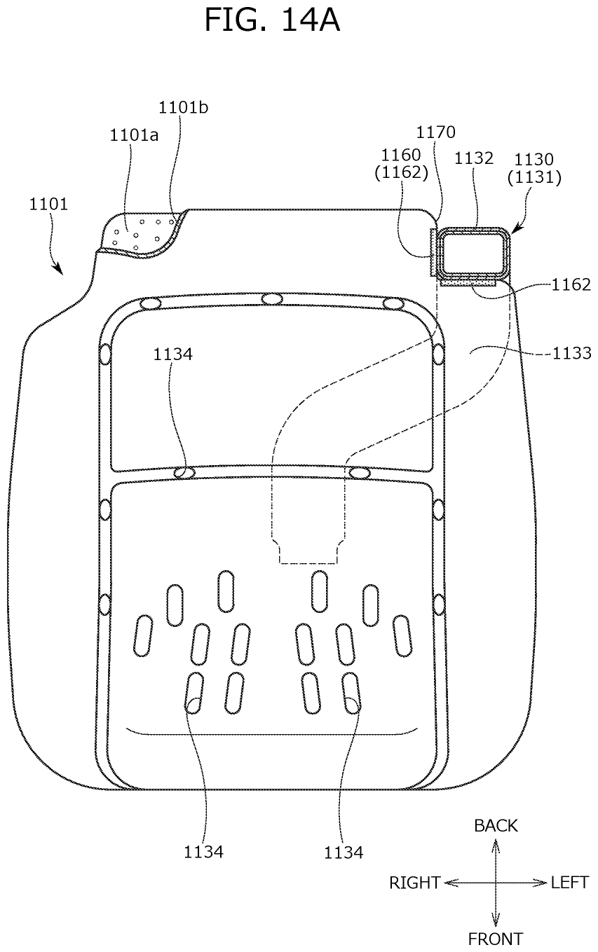

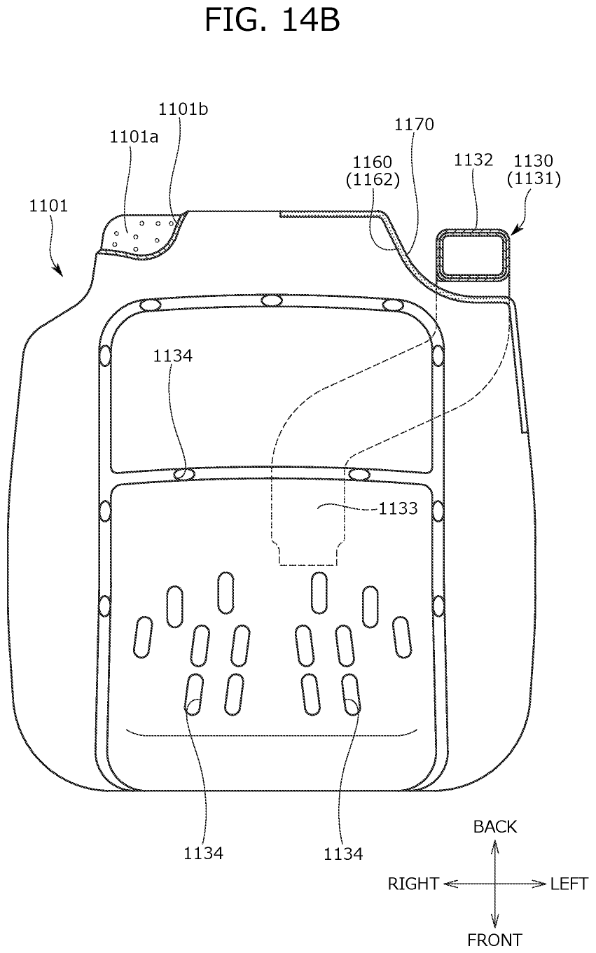

Next, a vehicle seat S2 of a second embodiment will be described with reference to FIGS. 13 to 14A and 14B.

It should be noted that description of content that overlaps with the vehicle seat S1 described above will be omitted.

The vehicle seat S2 is provided with a blower device in the seat main body and realizes a seat where a blower device duct disposition space can be ensured suitably.

In addition, the vehicle seat S2 realizes a seat where unintended skin material-duct contact in the seat main body can be suppressed.

As illustrated in FIGS. 13 and 14A, the vehicle seat S2 includes a seat cushion 1101, a seat back 1102, and a blower device 1130 attached in the seat cushion 1101.

In the seat cushion 1101, a pad material 1101a and a skin material 1101b are bonded by an adhesion portion 1160.

The blower device 1130 is attached to the bottom surface of the seat cushion 1101 (pad material 1101a).

The blower device 1130 is configured to blow out air from a blower main body 1131 toward an occupant (seated occupant) through a duct 1132, a ventilation path 1133 formed in the pad material 1101a, and a ventilation hole 1134.

The duct 1132 is disposed at the rear end part of the left side position of the seat cushion 1101 (pad material 1101a) and extends along the up to down direction.

Specifically, the duct 1132 is disposed at a position avoiding the pad material 1101a and extends along the up to down direction so as to face the outer edge part of the pad material 1101a.

In other words, a notch portion 1170 (duct escape portion) for non-interference with the duct 1132 is formed at the part of the pad material 1101a corresponding to the duct 1132.

The adhesion portion 1160 is a part provided with an adhesive and is applied to the surface of the pad material 1101a continuously or at a predetermined interval along the seat front to back direction and the seat width direction.

The adhesion portion 1160 has an upper surface adhesion portion 1161 applied to the upper surface of the pad material 1101a and a side surface adhesion portion 1162 applied to the outside surface of the pad material 1101a.

In the above configuration, as illustrated in FIG. 14A, the side surface adhesion portion 1162 is formed at the part of the outer edge part of the pad material 1101a that is adjacent (close) to the duct 1132.

By doing so, the pad material 1101a and the skin material 1101b can be suitably brought into close contact with each other around the duct 1132 and unintended contact between the skin material 1101b and the duct 1132 can be suppressed.

In other words, the skin material 1101b does not unintentionally swing and move around the duct 1132 (for example, above the duct 1132) and it is possible to suppress the generation of abnormal noise attributable to contact between the skin material 1101b and the duct 1132. It is also possible to ensure a passage area for the duct 1132 and increase the passage area.

It should be noted that as Modification Example 1 of the seat cushion 1101, the curved notch portion 1170 (duct escape portion) may be formed at the outer edge part of the pad material 1101a as illustrated in FIG. 14B. Further, it is preferable that the side surface adhesion portion 1162 is provided in the notch portion 1170.

By doing so, unintended contact between the skin material 1101b and the duct 1132 can be further suppressed.

### Third Embodiment

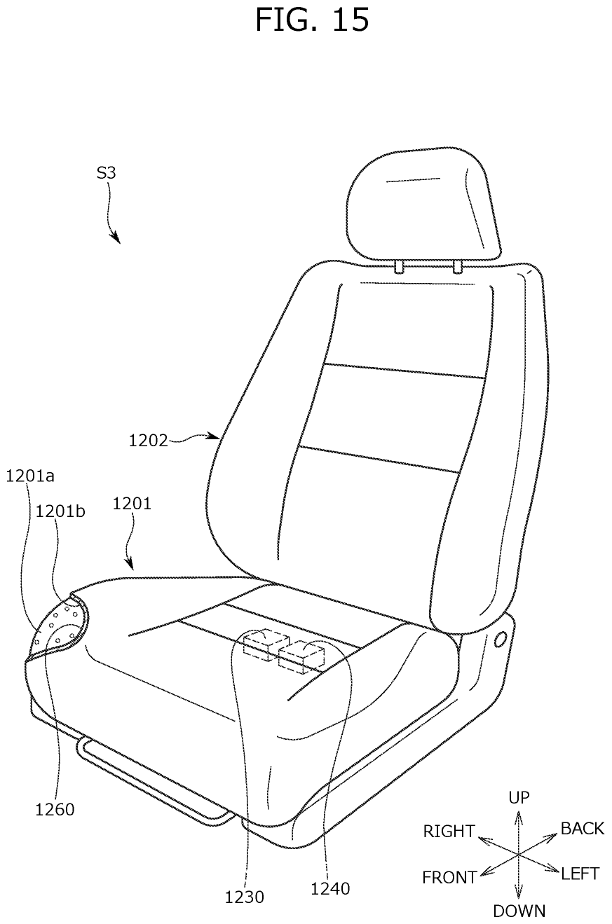

Next, a vehicle seat S3 of a third embodiment will be described with reference to FIGS. 15 to 17D.

It should be noted that description of content that overlaps with the vehicle seats S1 to S2 described above will be omitted.

The vehicle seat S3 is provided with a blower device in the seat main body and realizes a seat where an air conditioning capacity can be ensured with the blower device regardless of skin material attachment means.

In addition, the vehicle seat S3 is provided with a detection sensor (seating sensor) in the seat main body and realizes a seat where the accuracy of detection by the detection sensor can be enhanced regardless of the skin material attachment means.

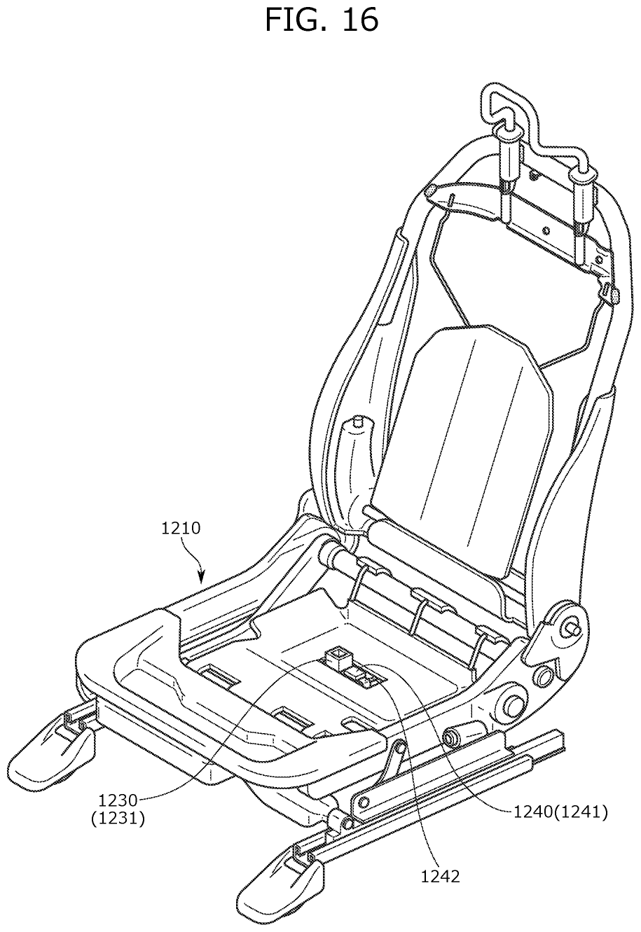

As illustrated in FIGS. 15 and 16, the vehicle seat S3 includes a seat cushion 1201, a seat back 1202, a blower device 1230 attached in the seat cushion 1201, and a detection sensor 1240 attached in the seat cushion 1201.

In the seat cushion 1201, a pad material 1201a and a skin material 1201b are bonded by adhesion portions 1260.

The detection sensor 1240 is a planar pressure sensor that detects the seating pressure of a seated occupant and is also called a seating sensor.

As illustrated in FIG. 16, the detection sensor 1240 is attached to the middle portion of a cushion frame 1210 in the seat front to back direction and the seat width direction.

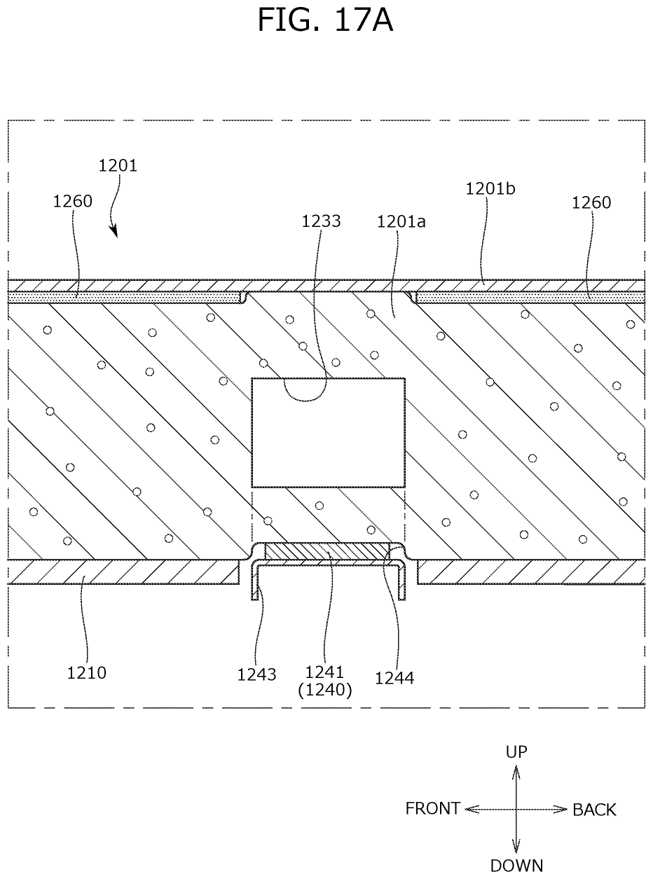

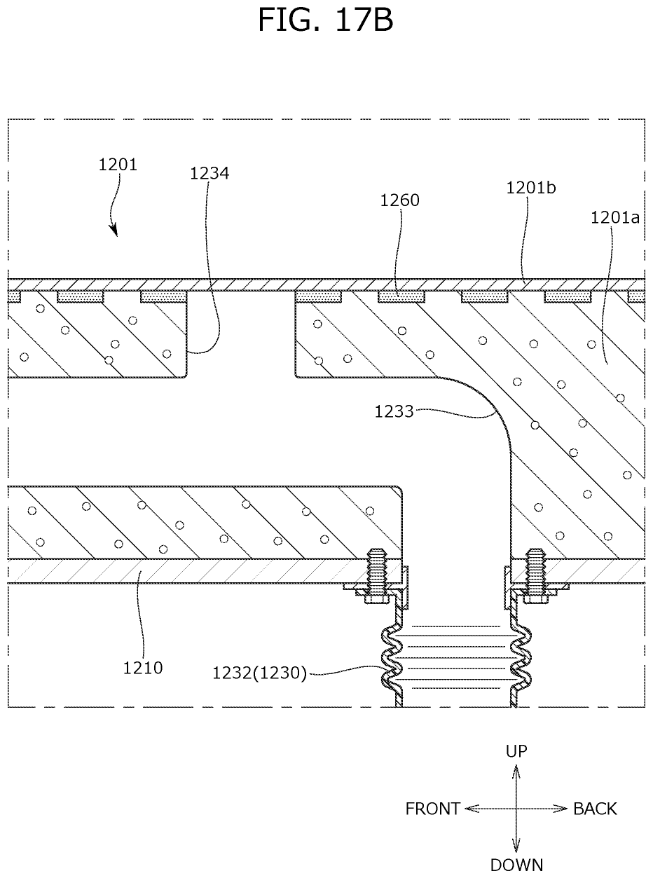

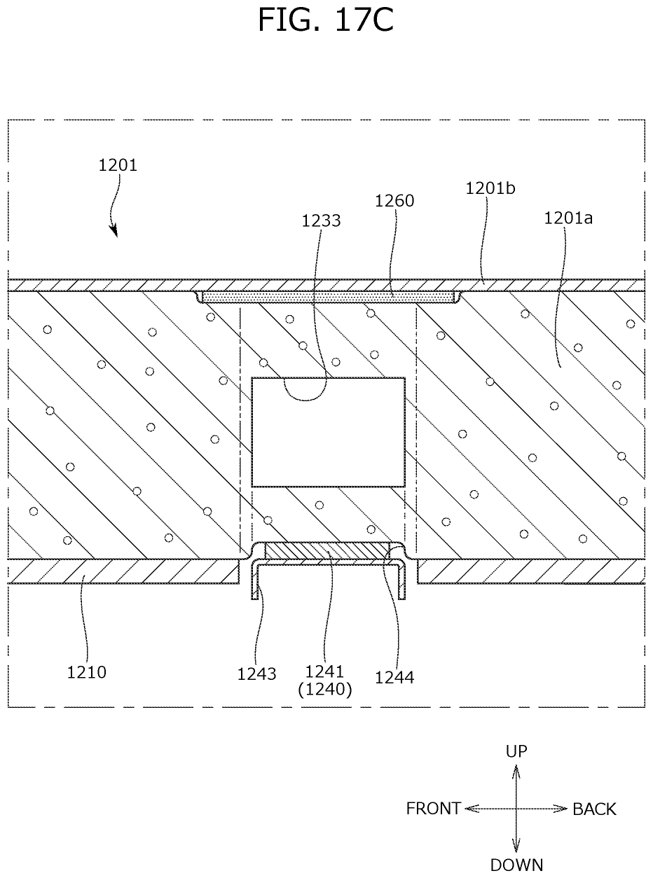

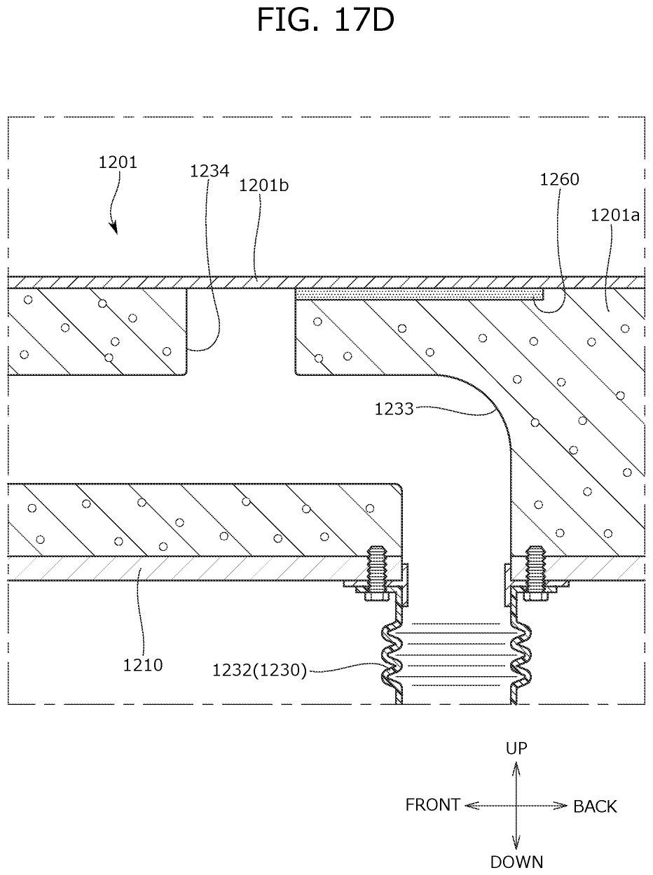

As illustrated in FIG. 17A, the detection sensor 1240 has a detection unit 1241 detecting the seating pressure of a seated occupant and a transmission path 1242 for transmitting detection data obtained by the detection unit 1241 toward a control device (not illustrated).

The detection unit 1241 abuts against the bottom surface of the pad material 1201a.

Specifically, the detection sensor 1240 (detection unit 1241) is attached on the cushion frame 1210 via an attachment bracket 1243.

In addition, the detection sensor 1240 is stored in a sensor storage recess 1244 formed on the bottom surface of the pad material 1201a.

In the above configuration, as illustrated in FIG. 17A, the detection sensor 1240 is disposed at a position different from the adhesion portions 1260 bonding the pad material 1201a and the skin material 1201b in the seat front to back direction and the seat width direction.

In other words, the detection sensor 1240 is disposed at a position that does not face “adhesion region” where the adhesion portions 1260 are formed.

By doing so, it is possible to ensure the accuracy of detection by the detection sensor 1240 regardless of the attachment means for the skin material 1201b (without being affected by adhesion).

As illustrated in FIGS. 16, 17A, and 17B, the blower device 1230 is attached to the bottom surface of the cushion frame 1210.

The blower device 1230 is configured to blow out air toward an occupant through a duct 1232, a ventilation path 1233, and a plurality of ventilation holes 1234.

As illustrated in FIG. 17B, the duct 1232 is attached to the cushion frame 1210 via an attachment bracket 1235 and extends in the up to down direction.

As illustrated in FIGS. 17A and 17B, the ventilation path 1233 is connected to the duct 1232 and branches into a plurality of paths so as to extend in the seat front to back direction and the seat width direction.

The plurality of ventilation holes 1234 are connected to the ventilation path 1233 and extend in the up to down direction.

In the above configuration, as illustrated in FIG. 17A, the ventilation path 1233 is disposed at a position that does not face “adhesion region” where the adhesion portions 1260 are formed. In addition, as illustrated in FIG. 17B, the ventilation path 1233 is disposed at a position that does not face “adhesion region”.

Alternatively, as illustrated in FIG. 17B, the duct 1232 and the ventilation path 1233 are disposed at positions that face “partial adhesion region” where the adhesion portions 1260 are formed at intervals.

In other words, the duct 1232, the ventilation path 1233, and the ventilation hole 1234 are disposed at positions avoiding “complete adhesion region” where the adhesion portions 1260 are formed continuously.

By doing so, an air conditioning capacity can be easily ensured with the blower device 1230 regardless of the attachment means for the skin material 1201b (without being affected by adhesion).

In addition, “partial adhesion region” where the adhesion portions 1260 are formed at intervals is a high-hardness region where the pad material 1201a is relatively high in hardness. Therefore, it is possible to suppress the seating load from an occupant or the like affecting the air conditioning passage.

It should be noted that as Modification Example 2 of the seat cushion 1201, as illustrated in FIGS. 17C and 17D, the detection sensor 1240, the duct 1232, the ventilation path 1233, and the ventilation hole 1234 may be disposed respectively.

The detection sensor 1240 is disposed at a position that faces “adhesion region” where the adhesion portion 1260 is formed.

Further, the peripheral position of the detection sensor 1240 is disposed so as to face “non-adhesion region” where the adhesion portion 1260 is not formed. It should be noted that the peripheral position of the detection sensor 1240 may face “partial adhesion region”.

By doing so, it is also possible to ensure the accuracy of detection by the detection sensor 1240.

In addition, as illustrated in FIGS. 17C and 17D, the ventilation path 1233 is disposed at a position that faces “complete adhesion region” where the adhesion portions 1260 are formed continuously or “partial adhesion region” where the adhesion portions 1260 are formed at intervals.

In addition, as illustrated in FIG. 17D, the duct 1232 is disposed at a position that faces “partial adhesion region”.

“Complete adhesion region” and “partial adhesion region” are high-hardness regions where the pad material 1201a is relatively high in hardness.

By doing so, it is possible to suppress the seating load from an occupant or the like affecting the air conditioning passage and a decline in air conditioning capacity can be suppressed.

### Fourth Embodiment

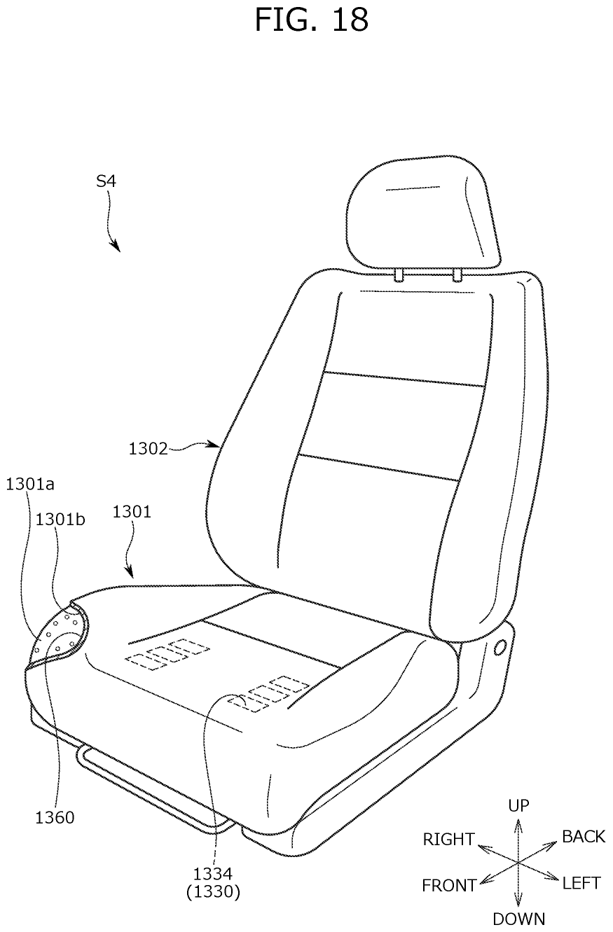

Next, a vehicle seat S4 of a fourth embodiment will be described with reference to FIGS. 18 to 20.

It should be noted that description of content that overlaps with the vehicle seats S1 to S3 described above will be omitted.

The vehicle seat S4 is provided with a blower device in the seat main body and realizes a seat where an air conditioning capacity can be ensured with the blower device regardless of skin material attachment means.

The vehicle seat S4 includes a seat cushion 1301, a seat back 1302, and a blower device 1330 attached in the seat cushion 1301.

In the seat cushion 1301, a pad material 1301a and a skin material 1301b are bonded by an adhesion portion 1360.

As illustrated in FIGS. 18 to 20, the blower device 1330 is attached to the bottom surface of a cushion frame 1310.

The blower device 1330 is configured to blow out air toward an occupant through a duct 1332, a ventilation path 1333, and a plurality of ventilation holes 1334.

The plurality of ventilation holes 1334 are disposed side by side in the seat front to back direction and are disposed at intervals in the seat width direction.

The front part of the seat cushion 1301 where the plurality of ventilation holes 1334 are formed is “ventilation region”. In addition, the rear part of the seat cushion 1301 where the ventilation hole 1334 is not formed is “non-ventilation region”.

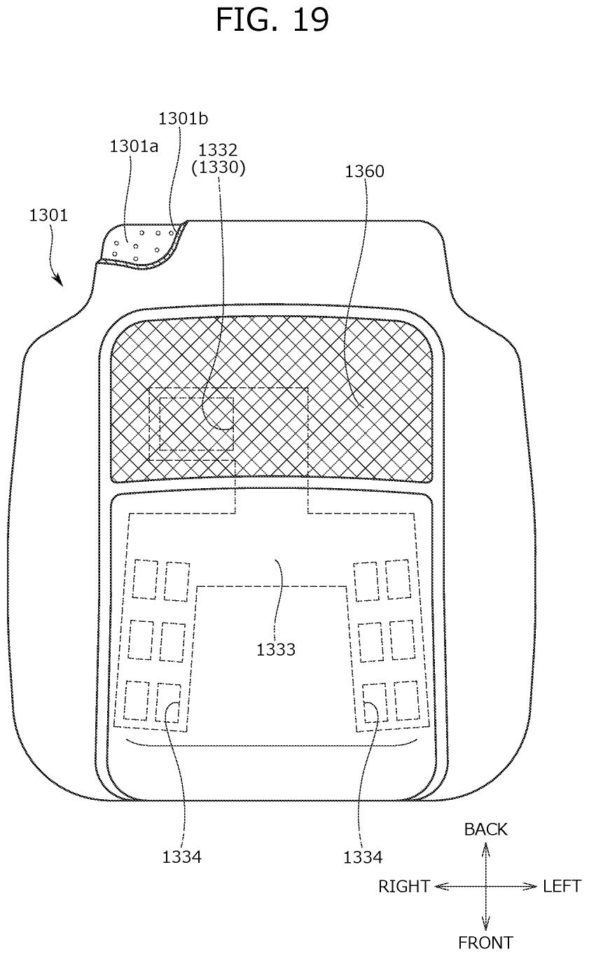

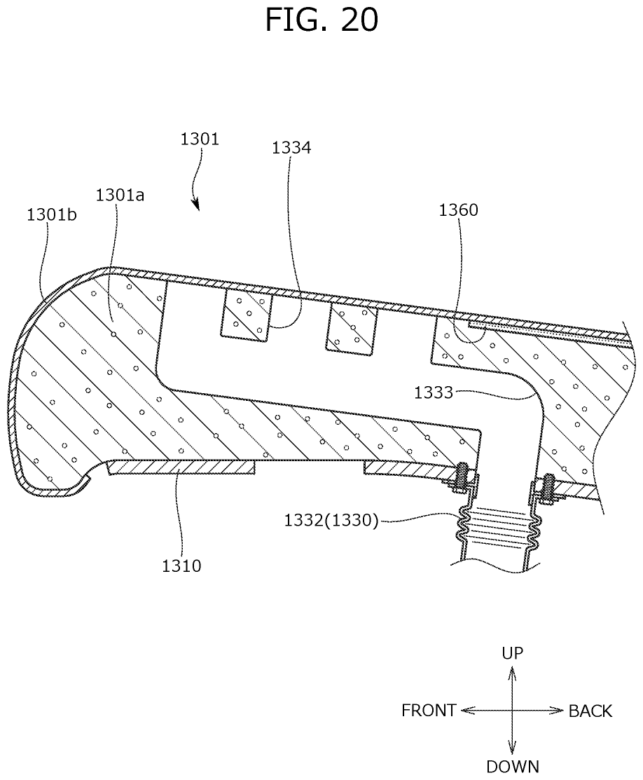

In the above configuration, as illustrated in FIGS. 19 and 20, “ventilation region” of the seat cushion 1301 where the plurality of ventilation holes 1334 are formed is configured to correspond to “non-adhesion region” where the adhesion portion 1360 is not provided.

In addition, “non-ventilation region” of the seat cushion 1301 where the ventilation hole 1334 is not formed is configured to correspond to “adhesion region” where the adhesion portion 1360 is provided.

Further, the area of “ventilation region (non-adhesion region)” is larger than the area of “non-ventilation region (adhesion region)”.

By doing so, an air conditioning capacity can be ensured with the blower device 1330 regardless of the attachment means for the skin material 1301b (without being affected by adhesion).

In addition, the skin material 1301b can be suitably bonded and fixed to the pad material 1301a.

In addition, in the above configuration, as illustrated in FIG. 19, the plurality of ventilation holes 1334 are disposed side by side in the seat front to back direction and are disposed at intervals in the seat width direction.

Likewise, “adhesion region” formed by the adhesion portion 1360 also extends along the seat front to back direction and the seat width direction.

By doing so, it is possible to effectively use spaces to suitably ensure air conditioning by means of the blower device 1330 and adhesiveness by means of the adhesion portion 1360.

It should be noted that although “ventilation region” of the seat cushion 1301 where the plurality of ventilation holes 1334 are formed corresponds to “non-adhesion region” as illustrated in FIG. 19, “ventilation region” may correspond to “partial adhesion region” where the adhesion portion 1360 is formed at an interval.

By doing so, it is also possible to ensure an air conditioning capacity with the blower device 1330.

### Fifth Embodiment

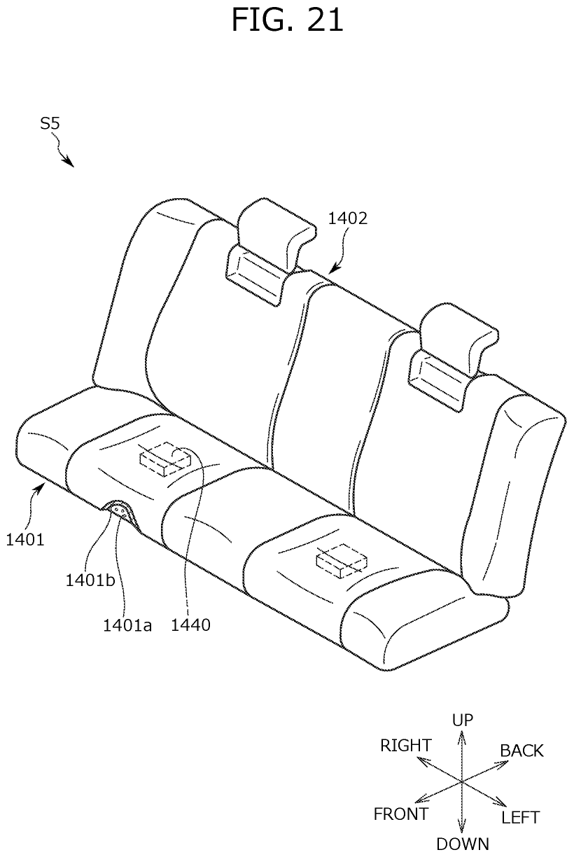

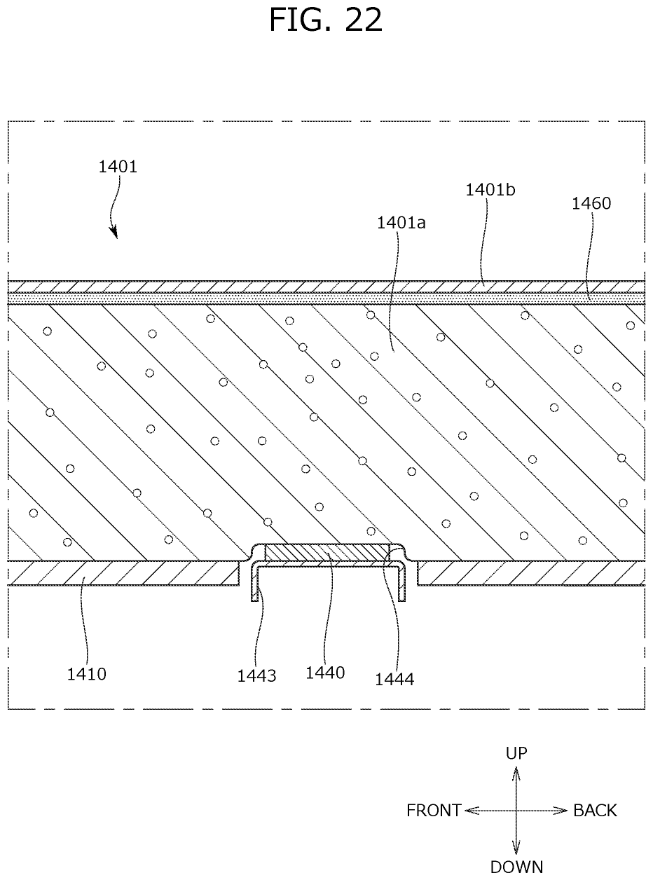

Next, a vehicle seat S5 of a fifth embodiment will be described with reference to FIGS. 21 to 22.

It should be noted that description of content that overlaps with the vehicle seats S1 to S4 described above will be omitted.

The vehicle seat S5 is provided with a detection sensor (seating sensor) in the seat main body and realizes a seat where the accuracy of detection by the detection sensor can be ensured regardless of the skin material attachment means.

The vehicle seat S5 includes a seat cushion 1401, a seat back 1402, and a detection sensor 1440 attached in the seat cushion 1401.

In the seat cushion 1401, a pad material 1401a and a skin material 1401b are bonded by an adhesion portion 1460.

The detection sensor 1440 is a planar pressure sensor that detects the seating pressure of a seated occupant.

The detection sensor 1440 is attached on an attachment bracket 1443 fixed on the vehicle body floor.

Further, the detection sensor 1440 is disposed so as to abut against the bottom surface of the pad material 1201a through the opening portion of a cushion frame 1410.

Specifically, the detection sensor 1440 is stored in a sensor storage recess 1444 formed on the bottom surface of the pad material 1401a.

By disposing the detection sensor 1440 on the bottom surface of the pad material 1401a as described above, the detection sensor 1440 can be disposed regardless of the attachment means for the skin material 1401b (without being affected by adhesion).

In addition, “adhesion region” where the adhesion portion 1460 is formed is a high-hardness region where the pad material 1401a is relatively high in hardness. Therefore, the seating load from an occupant can be suitably transferred to the detection sensor 1440 and the accuracy of detection by the detection sensor 1440 can be ensured.

It should be noted that although the attachment bracket 1443 is fixed on the vehicle body floor as illustrated in FIG. 22, the attachment bracket 1443 is not particularly limited and may be fixed to the cushion frame 1410 or the pad material 1401a.

In a case where the attachment bracket 1443 is fixed to the pad material 1401a, it is preferable that the attachment bracket 1443 is fixed to the pad material 1401a with an adhesive. Alternatively, the attachment bracket 1443 may be integrated with the pad material 1401a by integral foam molding.

### Sixth Embodiment

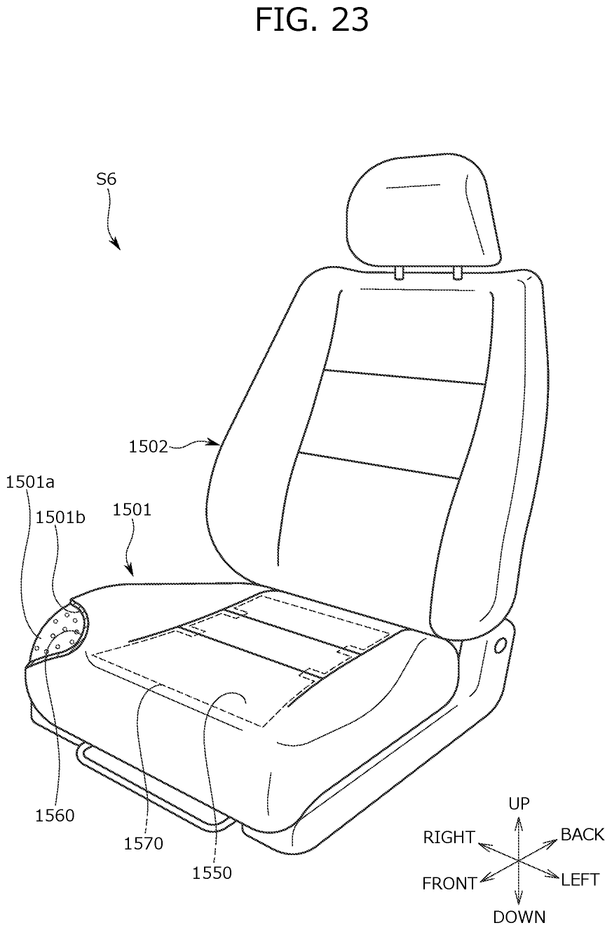

Next, a vehicle seat S6 of a sixth embodiment will be described with reference to FIGS. 23 to 25.

It should be noted that description of content that overlaps with the vehicle seats S1 to S5 described above will be omitted.

The vehicle seat S6 is provided with a seat heater in the seat main body and realizes a seat devised so as not to affect the attachment state (adhesion state) of the seat heater even in a case where the pad material and the skin material are fixed with an adhesive.

The vehicle seat S6 includes a seat cushion 1501, a seat back 1502, and a seat heater 1550 attached in the seat cushion 1501.

In the seat cushion 1501, a pad material 1501a and a skin material 1501b are bonded by an adhesion portion 1560.

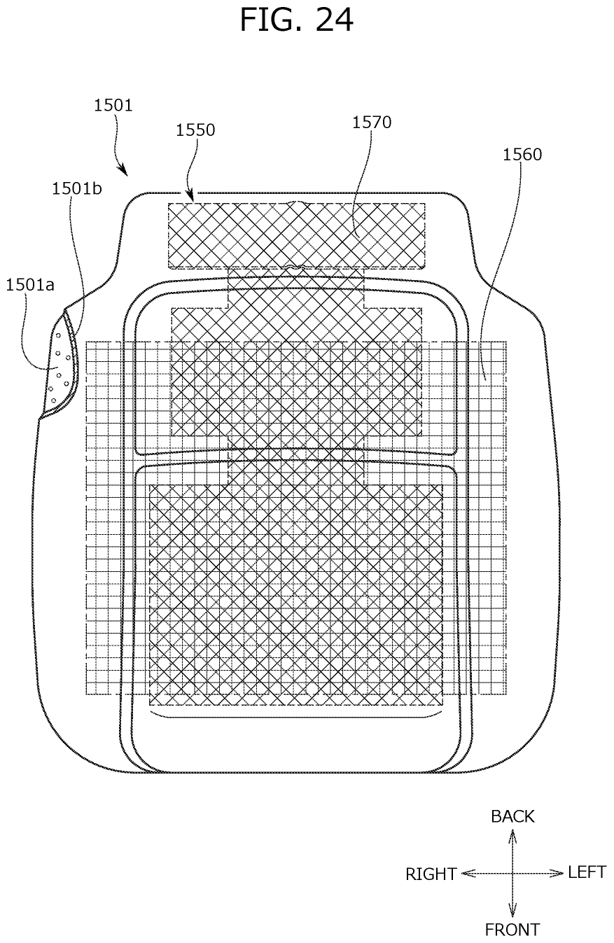

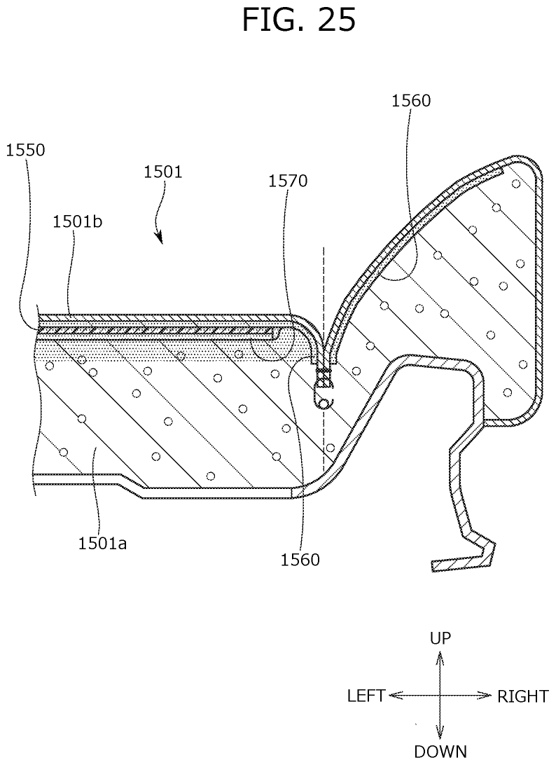

As illustrated in FIGS. 24 and 25, the seat heater 1550 is a planar heating element that warms the seat cushion 1501 and is attached to the surface of the pad material 1501a by an adhesion portion 1570.

As illustrated in FIGS. 24 and 25, “first adhesion region” where the pad material 1501a and the skin material 1501b are bonded by the adhesion portion 1560 is a region wider in the seat width direction than in the seat front to back direction.

In addition, “second adhesion region” where the pad material 1501a and the seat heater 1550 are bonded by the adhesion portion 1570 is a region wider in the seat front to back direction than in the seat width direction.

“First adhesion region” and “second adhesion region” are disposed so as to partially overlap in the middle portion of the seat cushion 1501.

It should be noted that “first adhesion region” and “second adhesion region” may be disposed so as not to overlap. In other words, “first adhesion region” formed by the adhesion portion 1560 may be formed so as to avoid “second adhesion region” formed by the adhesion portion 1570.

In the above configuration, the adhesive-attributable melting point of the adhesion portion 1560 and the adhesive-attributable melting point of the adhesion portion 1570 differ from each other. Specifically, the melting point of the adhesion portion 1560 is lower than the melting point of the adhesion portion 1570.

By doing so, the adhesion state of the adhesion portion 1570 is not affected in a case where the skin material 1501b is further bonded by the adhesion portion 1560 after the seat heater 1550 is bonded to the pad material 1501a by the adhesion portion 1570.

In other words, when the pad material 1501a and the skin material 1501b are bonded by the adhesion portion 1560, it is possible to suppress the adhesion portion 1570 being affected by performing heating and melting at a temperature higher than the melting point of the adhesion portion 1560 and lower than the melting point of the adhesion portion 1570.

With the above configuration, it is possible to realize the vehicle seat devised so as not to affect the attachment state (adhesion state) of the seat heater 1550 even in a case where the pad material 1501a and the skin material 1501b are fixed with an adhesive.

### Seventh Embodiment

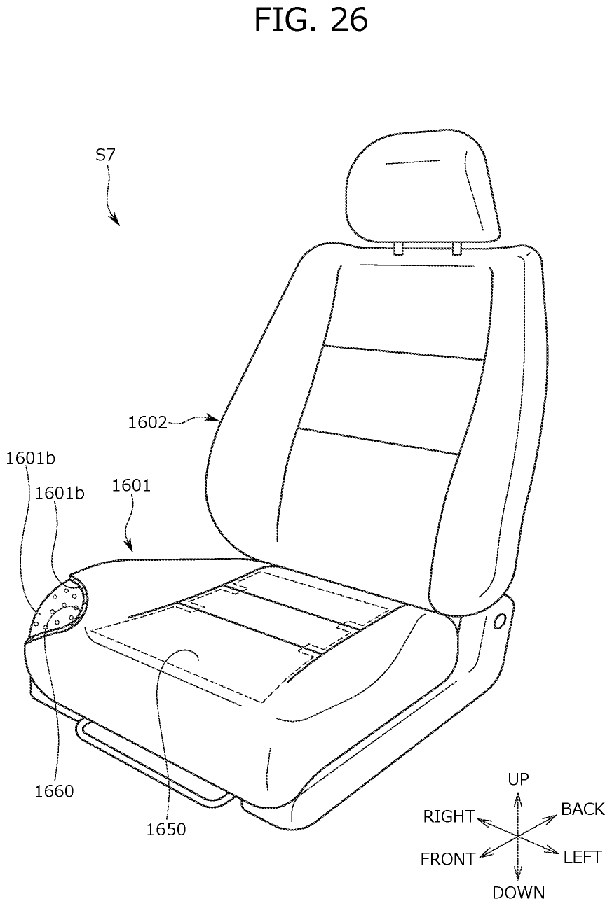

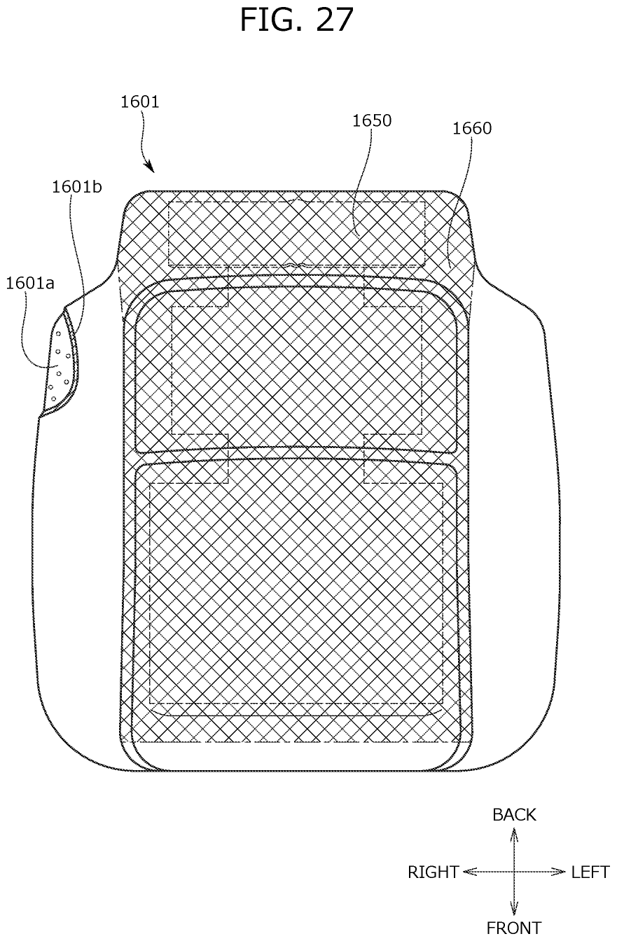

Next, a vehicle seat S7 of a seventh embodiment will be described with reference to FIGS. 26 to 27.

It should be noted that description of content that overlaps with the vehicle seats S1 to S6 described above will be omitted.

The vehicle seat S7 is provided with a seat heater in the seat main body and realizes a seat where the seat heater and the skin material can be efficiently attached to the pad material.

The vehicle seat S7 includes a seat cushion 1601, a seat back 1602, and a seat heater 1650 attached in the seat cushion 1601.

In the seat cushion 1601, a pad material 1601a and a skin material 1601b are bonded by an adhesion portion 1660.

The seat heater 1650 is a planar heating element that warms the seat cushion 1601 and is attached to the surface of the pad material 1601a.

The adhesion portion 1660 is a part provided with an adhesive and is applied to the surface of the pad material 1601a.

“Adhesion region” where the adhesion portion 1660 is provided is formed to be larger than the seat heater 1650 and wider than the seat heater 1650 in the seat front to back direction and the seat width direction.

“Adhesion region” is disposed between the pad material 1601a and the seat heater 1650 in the up to down direction and is disposed between the pad material 1601a and the skin material 1601b in the up to down direction.

In the above configuration, the adhesion portion 1660 is capable of bonding both the seat heater 1650 and the skin material 1601b to the pad material 1601a.

In other words, the part that overlaps the seat heater 1650 in “adhesion region” where the adhesion portion 1660 is provided is where the seat heater 1650 is bonded to the pad material 1601a.

Further, the part of “adhesion region” that does not overlap the seat heater 1650 is where the skin material 1601b is bonded to the pad material 1601a.

With the above configuration, it is possible to realize the vehicle seat where the seat heater 1650 and the skin material 1601b can be efficiently attached to the pad material 1601a.

Specifically, the seat heater 1650 and the skin material 1601b can be simultaneously bonded to the pad material 1601a in one work process (adhesion work process).

It should be noted that the seat heater 1650 may be attached to the back surface of the skin material 1601b by sewing. Even in this case, the seat heater 1650 and the skin material 1601b can be simultaneously bonded to the pad material 1601a in one work process.

### Eighth Embodiment

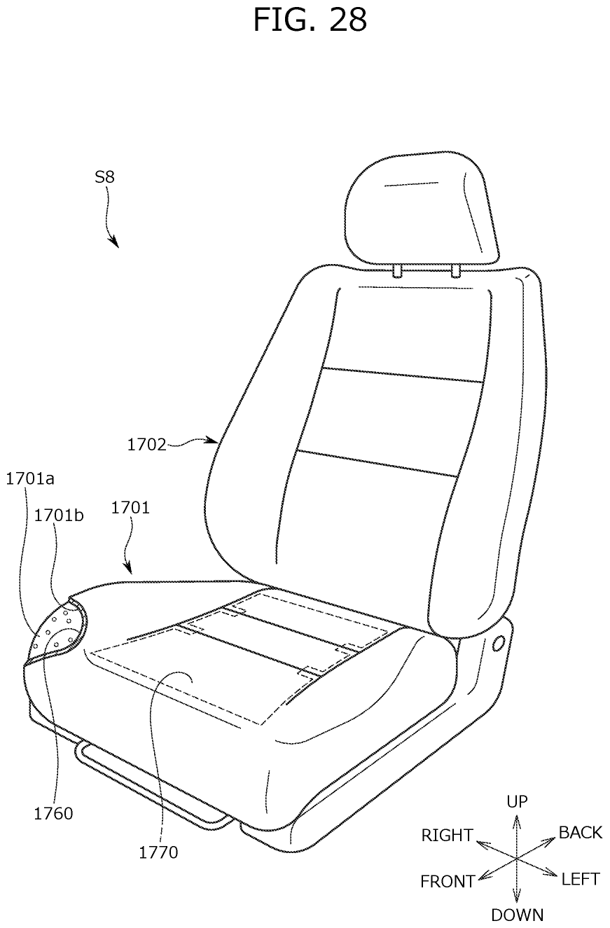

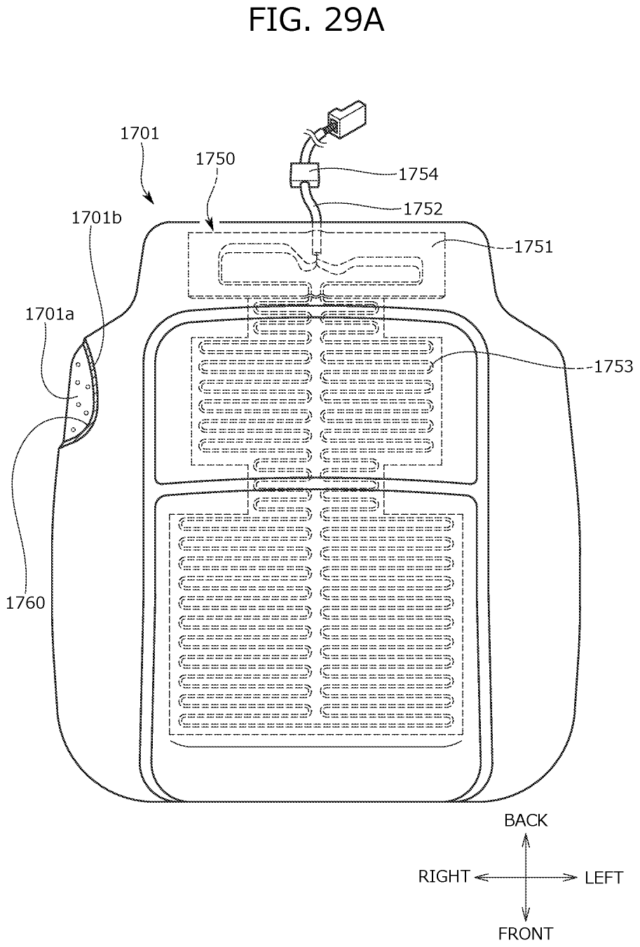

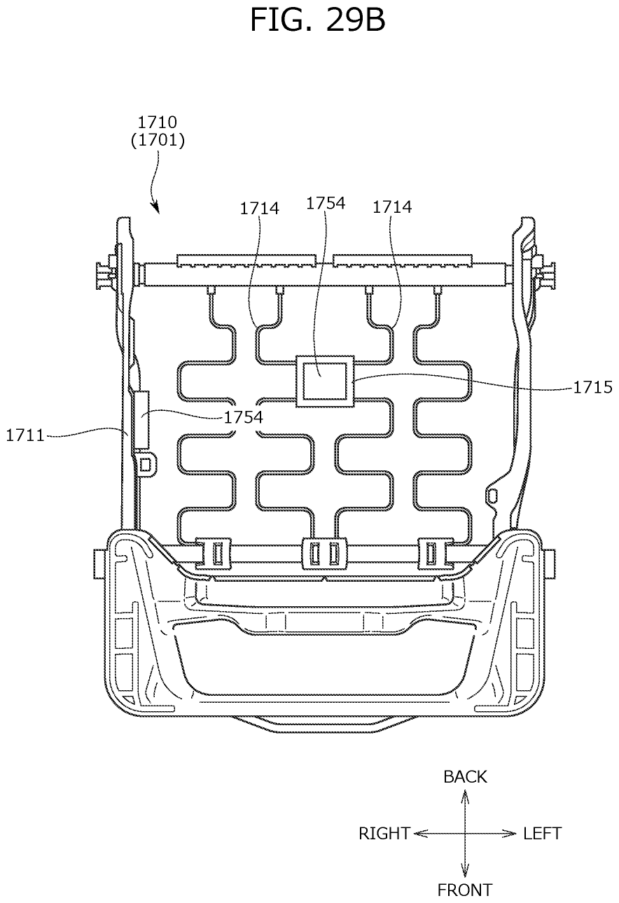

Next, a vehicle seat S8 of an eighth embodiment will be described with reference to FIGS. 28 to 29A and 29B.

It should be noted that description of content that overlaps with the vehicle seats S1 to S7 described above will be omitted.

The vehicle seat S8 is provided with a seat heater in the seat main body and realizes a seat devised so as not to affect the thermostat of the seat heater even in a case where the pad material and the skin material are fixed with an adhesive.

The vehicle seat S8 includes a seat cushion 1701, a seat back 1702, and a seat heater 1750 attached in the seat cushion 1701.

In the seat cushion 1701, a pad material 1701a and a skin material 1701b are bonded by an adhesion portion 1760.

The seat heater 1750 is attached to the surface of the pad material 1701a.

As illustrated in FIG. 29A, the seat heater 1750 has a sheet-shaped seat base material 1751, electric wires 1752 respectively attached on the seat base material 1751 and connected to a power source (not illustrated), a heater wire 1753 connected to the electric wire 1752, and a thermostat 1754 (temperature adjustment device) connected to the electric wire 1752 and the heater wire 1753.

The thermostat 1754 is disposed at a position different from the inside of the seat cushion 1701 (pad material 1701a).

Specifically, the thermostat 1754 is disposed outside the seat cushion 1701 and is disposed at a position behind the seat cushion 1701.

By doing so, the thermostat 1754 is not affected even in a case where the pad material 1701a and the skin material 1701b are bonded by heating and melting the adhesion portion 1760.

In other words, it is possible to realize the vehicle seat devised so as not to affect the thermostat 1754 even in a case where the pad material 1701a and the skin material 1701b are fixed with an adhesive.

It should be noted that the thermostat 1754 may be disposed at a position separated from the adhesion portion 1760 in the seat cushion 1701.

For example, as illustrated in FIG. 29B, the thermostat 1754 may be attached to a cushion frame 1710 (side frame 1711) or may be attached on a connecting clip 1715 provided on a plurality of elastic springs 1714.

### Ninth Embodiment

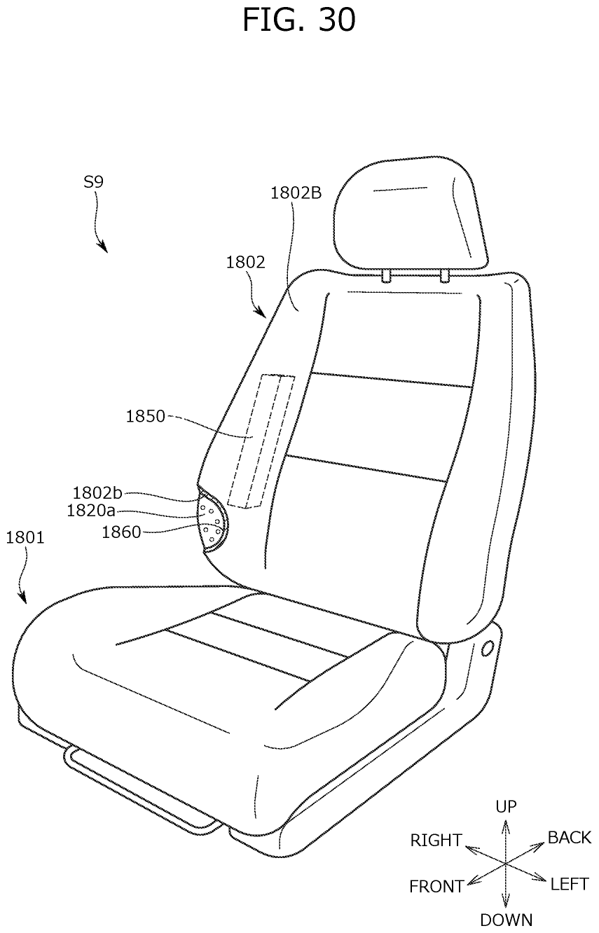

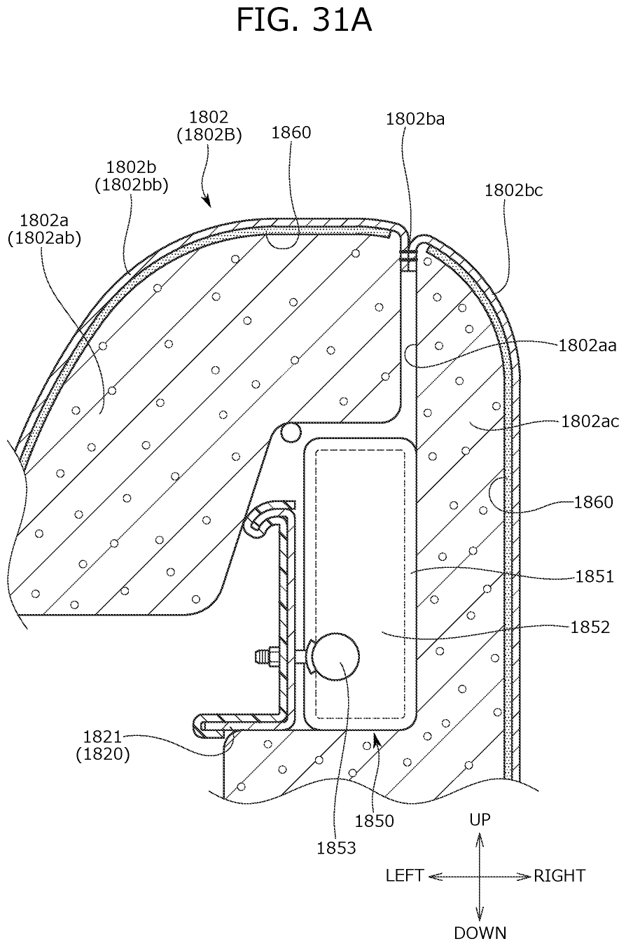

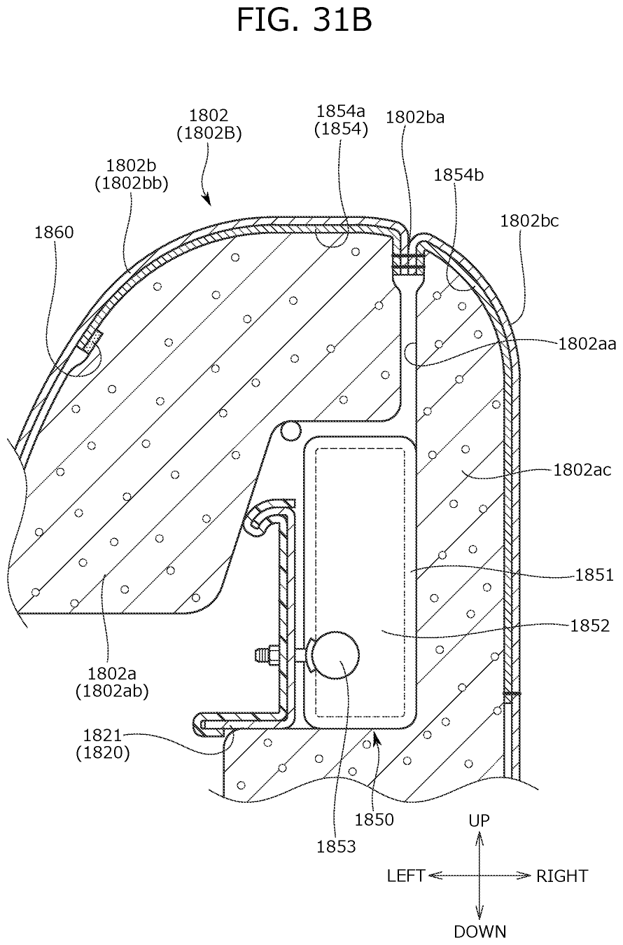

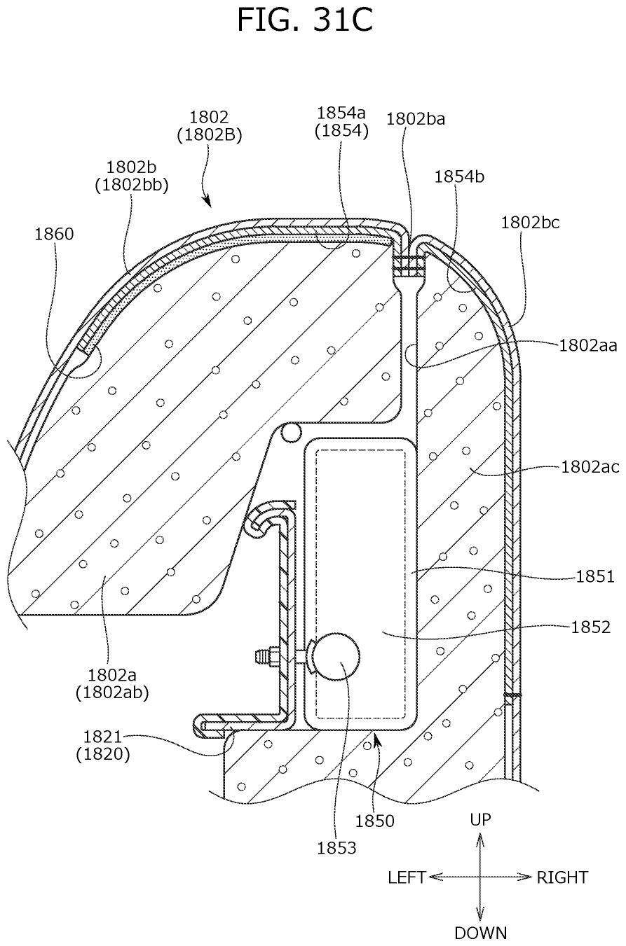

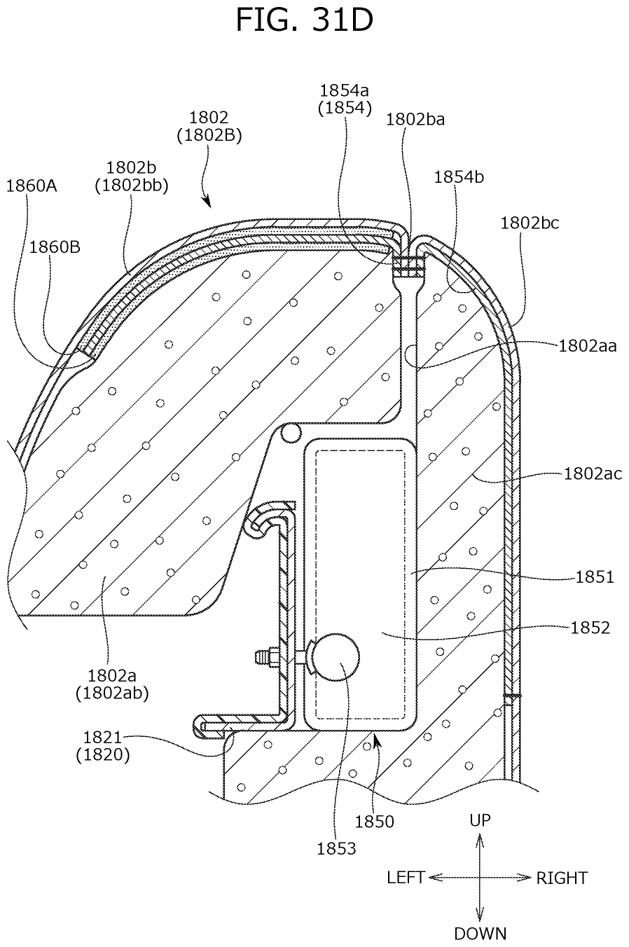

Next, a vehicle seat S9 of a ninth embodiment will be described with reference to FIGS. 30 and 31A to 31D.

It should be noted that description of content that overlaps with the vehicle seats S1 to S8 described above will be omitted.

The vehicle seat S9 is provided with an airbag device in the seat main body and realizes a seat devised so as not to affect airbag inflation deployment even in a case where the pad material and the skin material are fixed with an adhesive.

The vehicle seat S9 includes a seat cushion 1801, a seat back 1802, and a side airbag device 1850 attached in a side portion 1802B of the seat back 1802.

In the seat back 1802, a pad material 1802a and a skin material 1802b are bonded by an adhesion portion 1860.

As illustrated in FIG. 31A, the side airbag device 1850 has a configuration in which an airbag 1852 that is folded is inflation-deployed toward the seat front side when an impact is applied from the side of the vehicle body.

The side airbag device 1850 includes an airbag module 1851 provided in the pad material 1802a in the side portion 1802B of the seat back 1802 and attached to the outside surface of a back side frame 1821.

The airbag module 1851 has the airbag 1852 that is inflation-deployed toward the seat front side, an inflator 1853 that supplies a gas into the airbag 1852, and a harness (not illustrated) that is connected to the inflator 1853 and supplies power for ignition to the inflator 1853.

It should be noted that the harness is connected to a vehicle battery (not illustrated) disposed on the vehicle body.

When the airbag 1852 is inflation-deployed in the above configuration, the airbag 1852 is deployed by the pad material 1802a being divided into an inner pad 1802ab and an outer pad 1802ac with a pad through hole 1802aa serving as a branching point.

In addition, when the airbag 1852 is inflation-deployed, the airbag 1852 is deployed by the skin material 1802b being divided into an inner skin material 1802bb and an outer skin material 1802bc with the skin burst-open portion 1802ba serving as a branching point.

Therefore, the inflation deployment direction of the airbag can be stabilized.

In the above configuration, as illustrated in FIG. 31A, the adhesion portion 1860 (adhesion region) is disposed at the positions of the skin material 1802b that avoid the skin burst-open portion 1802ba and the periphery of the skin burst-open portion 1802ba.

By doing so, it is possible to realize the vehicle seat devised so as not to affect the inflation deployment of the airbag 1852 even in a case where the pad material 1802a and the skin material 1802b are fixed with an adhesive.

In addition, in the above configuration, the adhesion portion 1860 is formed along the extension direction of the skin burst-open portion 1802ba (up to down direction) and is disposed at positions sandwiching the skin burst-open portion 1802ba in the seat width direction.

By doing so, the skin material 1802b can be hardened with an adhesive around the skin burst-open portion 1802ba. As a result, it is possible to further suppress the skin material 1802b burst-opening at an unintended position when the airbag 1852 is inflation-deployed.

In addition, in a case where the side airbag device 1850 in the above configuration includes a guide member (stay cloth) that guides the deployment direction of the airbag 1852, it is preferable that the adhesion portion 1860 is disposed at a position avoiding the part of the skin material 1802b where the guide member is sewn.

By doing so, the deployment direction of the airbag 1852 can be more stabilized.

In addition, in a case where the side airbag device 1850 in the above configuration includes guide members 1854a and 1854b (inner stay cloth, outer stay cloth) as illustrated in FIG. 31B, it is preferable that the guide member 1854a is bonded to the pad material 1802a by the adhesion portion 1860. By doing so, the degree of freedom can be increased as to how to fix the guide member 1854a.

Specifically, in general, one end portion of the guide member 1854a is sewn to the skin burst-open portion 1802ba and the other end portion of the guide member 1854a is attached to a back frame 1820. On the other hand, in the present embodiment, the other end portion of the guide member 1854a is attached not to the back frame 1820 but to the pad material 1802a. By doing so, it is possible to increase the degree of freedom in disposing the guide member 1854a.

In addition, in the above configuration, it is preferable that only the other end portion of the guide member 1854a, which is one of the two end portions of the guide member 1854a and positioned on the side opposite to the skin burst-open portion 1802ba (weak portion), is bonded to the pad material 1802a as illustrated in FIG. 31B.

By doing so, the area of adhesion by the adhesion portion 1860 can be minimized and the amount of adhesion material application can be reduced.

In addition, in the above configuration, it is preferable that the guide member 1854a is bonded by the adhesion portion 1860 over the entire surface from one end portion positioned on the skin burst-open portion 1802ba (weak portion) side to the other end portion as illustrated in FIG. 31C.

By doing so, the guide member 1854a can be firmly attached to the pad material 1802a and the deployment direction of the airbag 1852 can be more stabilized.

In addition, in the above configuration, as illustrated in FIG. 31D, the pad material 1802a and the guide member 1854a may be bonded by an adhesion portion 1860A and the guide member 1854a and the skin material 1802b may be bonded by an adhesion portion 1860B.

By doing so, the guide member 1854 can be firmly attached to each of the pad material 1802a and the skin material 1802b. As a result, the deployment direction of the airbag 1852 can be further stabilized.

In addition, in a case where the skin material 1802b in the above configuration is formed by welding a plurality of skin pieces, it is preferable that the welding line and the skin burst-open portion 1802ba (weak portion) are formed at different positions.

By doing so, the deployment direction of the airbag 1852 can be stabilized even in a case where the skin material 1802b that is configured from a plurality of skin pieces is employed.

It should be noted that the skin burst-open portion 1802ba can be formed by embossing molding or the like.

### Tenth Embodiment

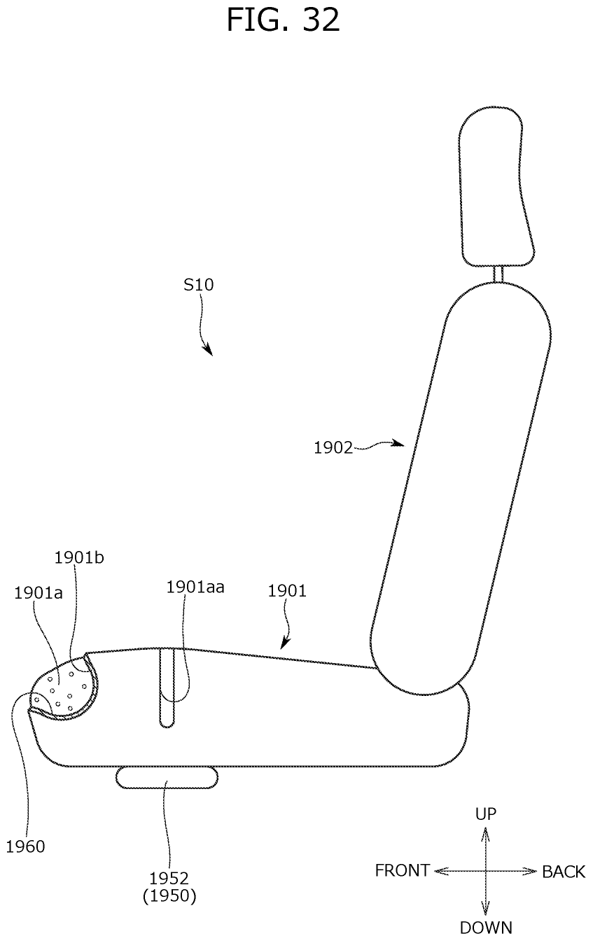

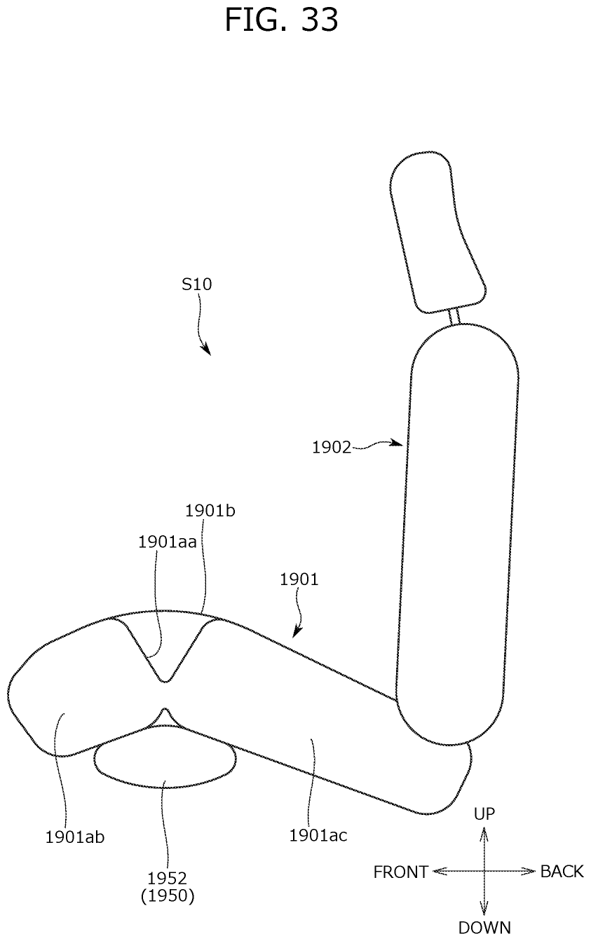

Next, a vehicle seat S10 of a tenth embodiment will be described with reference to FIGS. 32 and 33.

It should be noted that description of content that overlaps with the vehicle seats S1 to S9 described above will be omitted.

The vehicle seat S10 is provided with an airbag device and realizes a seat devised so as not to affect airbag inflation deployment even in a case where the pad material and the skin material are fixed with an adhesive.

The vehicle seat S10 includes a seat cushion 1901, a seat back 1902, and an airbag device 1950 attached to the lower part of the seat cushion.

In the seat cushion 1901, a pad material 1901a and a skin material 1901b are bonded by an adhesion portion 1960.

The airbag device 1950 has a configuration in which an airbag 1952 that is folded is inflation-deployed upward when an impact is applied from the outside.

The airbag device 1950 includes the airbag 1952 attached to the lower part of the seat cushion 1901.

When the airbag 1952 is inflation-deployed, the airbag 1952 is deployed by the pad material 1901a being divided into a front pad 1901ab and a rear pad 1901ac with a slit groove 1901aa (slit hole), which is formed on the surface of the pad material 1901a, serving as a branching point.

The slit groove 1901aa is formed so as to be elongated in the seat width direction.

In other words, the part of the pad material 1901a where the slit groove 1901aa is formed is a part where the adhesion portion 1960 is not provided.

With the above configuration, it is possible to realize the vehicle seat devised so as not to affect the inflation deployment of the airbag 1952 even in a case where the pad material 1901a and the skin material 1901b are fixed with an adhesive.

Specifically, as illustrated in FIG. 33, the pad part of the pad material 1901a that corresponds to the airbag 1952 suitably rises when the airbag 1952 is inflation-deployed.

### Eleventh Embodiment

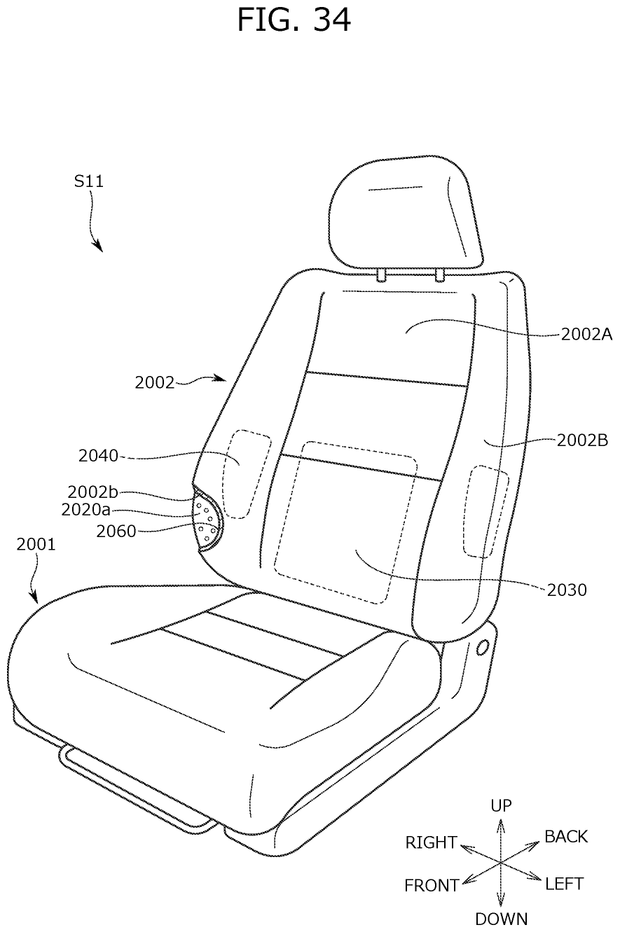

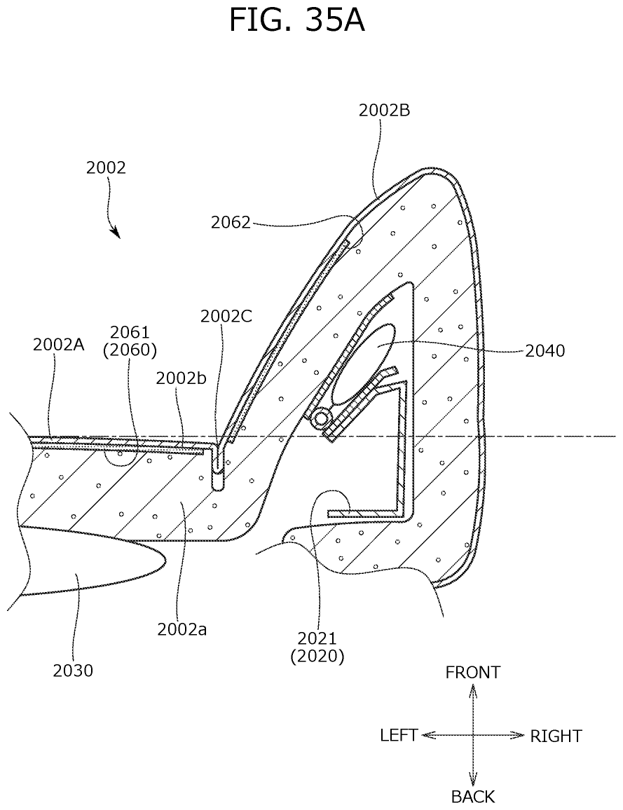

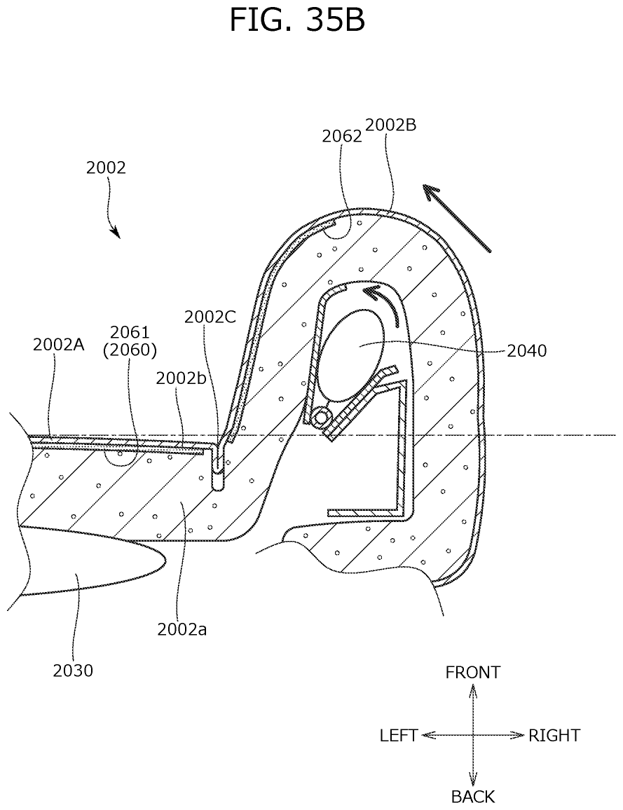

Next, a vehicle seat S11 of an eleventh embodiment will be described with reference to FIGS. 34, 35A, and 35B.

It should be noted that description of content that overlaps with the vehicle seats S1 to S10 described above will be omitted.

The vehicle seat S11 is provided with a movable body in the seat main body and realizes a seat devised so as not to affect the movable body being movable even in a case where the pad material and the skin material are fixed with an adhesive.

The vehicle seat S11 includes a seat cushion 2001, a seat back 2002, a lumbar support 2030 attached to a middle portion 2002A of the seat back 2002, and a movable body 2040 (side support member) attached to a side portion 2002B of the seat back 2002.

In the seat back 2002, a pad material 2002a and a skin material 2002b are bonded by an adhesion portion 2060.

The movable body 2040 is disposed between the pad material 2002a and a back side frame 2021 in the side portion 2002B of the seat back 2002.

The movable body 2040 is attached to the front surface of the back side frame 2021 in a folded state.

The movable body 2040 is capable of being movable so that the side portion 2002B is moved from “normal position” illustrated in FIG. 35A to “protruding position” illustrated in FIG. 35B.

The adhesion portion 2060 has a middle adhesion portion 2061 disposed in the middle portion 2002A of the seat back 2002 and a side adhesion portion 2062 disposed in the side portion 2002B.

In other words, the adhesion portion 2060 is formed in the seat back 2002 so as to straddle from the middle portion 2002A to the side portion 2002B.

By doing so, wrinkling of the skin material 2002b can be suppressed when the side portion 2002B is displaced by the movable body 2040.

The side adhesion portion 2062 is disposed at a position overlapping the movable body 2040 in the seat width direction and the up to down direction.

The side adhesion portion 2062 is disposed so as to avoid the part of the side portion 2002B that is easily deformed by the movable body 2040 being movable (specifically, most easily deformed part).

For example, the most easily deformed part of the side portion 2002B corresponds to the front end part of the side portion 2002B.

By forming “non-adhesion region” in this manner, the side portion 2002B can be smoothly displaced when the movable body 2040 is movable.

With the above configuration, it is possible to realize the vehicle seat devised so as not to affect the movable body 2040 being movable even in a case where the pad material 2002a and the skin material 2002b are fixed with an adhesive.

It should be noted that as illustrated in FIG. 35A, the adhesion portion 2060 is formed to avoid the skin end portion of the skin material 2002b that is pulled in a pull-in groove 2002C.

By doing so, the skin end portion becomes room for extension when the side portion 2002B is displaced by the movable body 2040. In other words, the side portion 2002B can be displaced further smoothly when the movable body 2040 is movable.

### Twelfth Embodiment

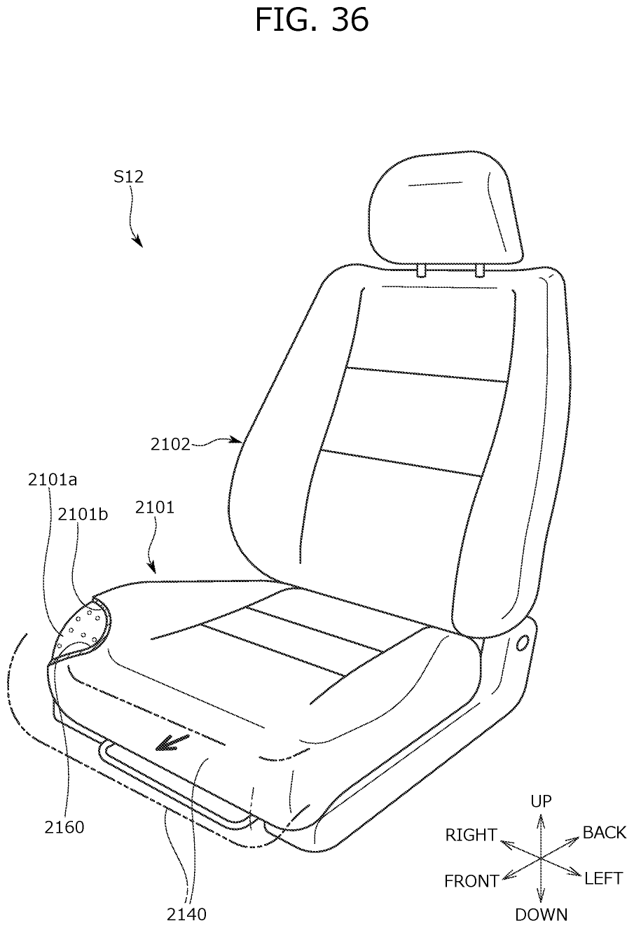

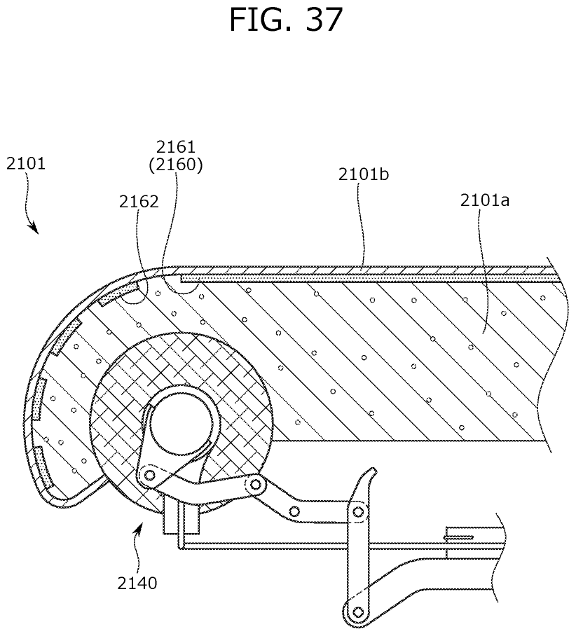

Next, a vehicle seat S12 of a twelfth embodiment will be described with reference to FIGS. 36 and 37.

It should be noted that description of content that overlaps with the vehicle seats S1 to S11 described above will be omitted.

The vehicle seat S12 is provided with a cushion length adjustment device in the seat cushion and realizes a seat devised so as not to affect the device being movable even in a case where the pad material and the skin material are fixed with an adhesive.

The vehicle seat S12 includes a seat cushion 2101, a seat back 2102, and a cushion length adjustment device 2140 attached to the front portion of the seat cushion 2101.

In the seat cushion 2101, a pad material 2101a and a skin material 2101b are bonded by an adhesion portion 2160.

The cushion length adjustment device 2140 is a device capable of adjusting the front to back length of the seat cushion 2101 and is movable so that the seat cushion 2101 is moved from “normal position” to “protruding position”.

Specifically, the cushion length adjustment device 2140 has a link mechanism and a winding mechanism.

When the seat cushion 2101 is at “normal position”, the link mechanism is folded and the winding mechanism operates so as to wind the front end portion of the seat cushion 2101.

When the seat cushion 2101 is at “protruding position”, the link mechanism is deployed and the winding mechanism operates so as to unwind the front end portion of the seat cushion 2101.

The adhesion portion 2160 has an upper adhesion portion 2161 disposed on the upper surface of the seat cushion 2101 and front adhesion portions 2162 disposed on the front surface of the seat cushion 2101.

The upper adhesion portion 2161 is configured by continuous adhesive application.

The front adhesion portions 2162 are configured by applying an adhesive at intervals and discontinuously.

The upper adhesion portion 2161 and the front adhesion portion 2162 elongatedly extend in the seat width direction.

By doing so, it is possible to suppress the skin material 2101b wrinkling and sagging when the seat cushion 2101 is displaced by the cushion length adjustment device 2140.

With the above configuration, it is possible to realize the vehicle seat devised so as not to affect the cushion length adjustment device 2140 being movable even in a case where the pad material 2101a and the skin material 2101b are fixed with an adhesive.

It should be noted that the cushion length adjustment device 2140 may have a slide mechanism without being limited to having the link mechanism and the winding mechanism.

Even in a case where the cushion length adjustment device 2140 has the slide mechanism, it is preferable not to apply an adhesive to the part of the skin material 2101b that requires room for extension.

By doing so, it is possible to suppress the skin material 2101b wrinkling and sagging when the seat cushion 2101 is displaced.

### Thirteenth Embodiment

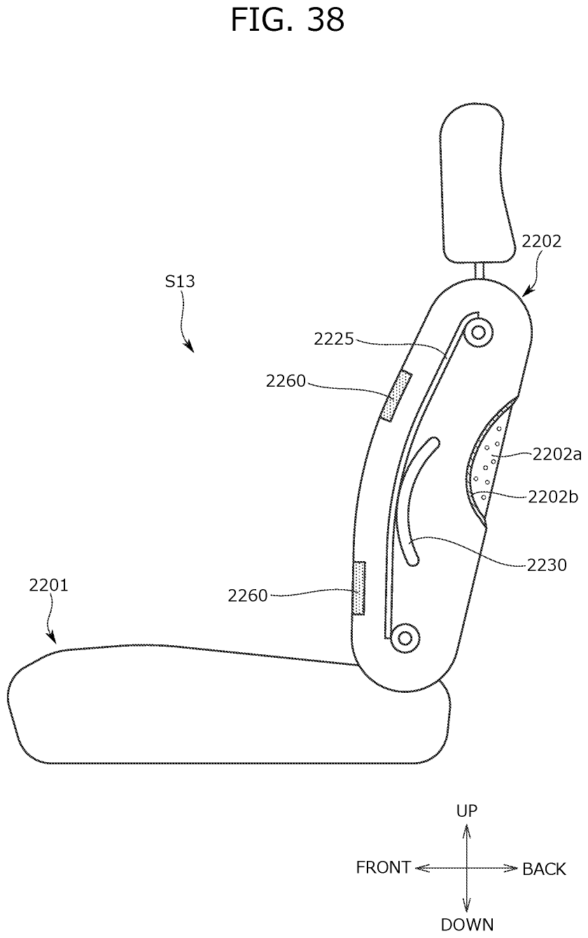

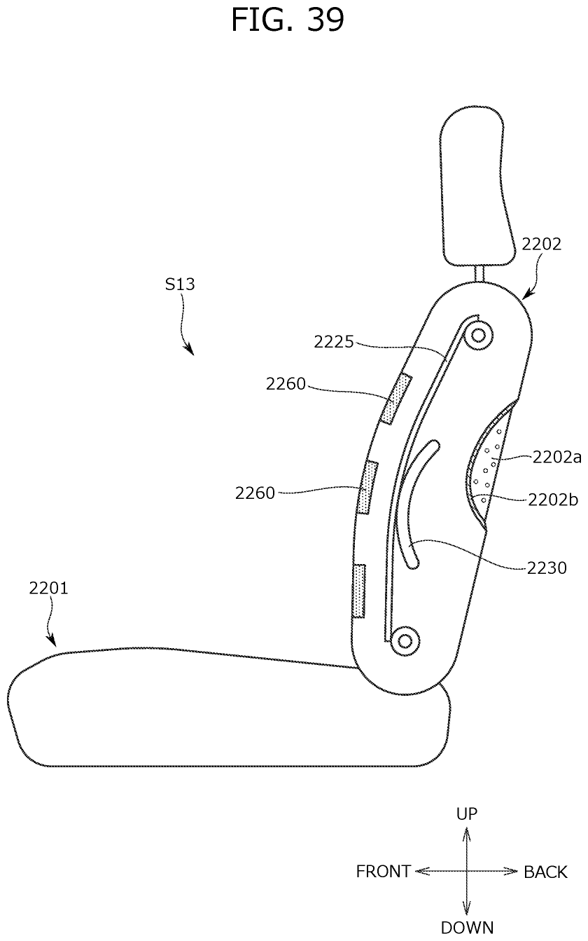

Next, a vehicle seat S13 of a thirteenth embodiment will be described with reference to FIGS. 38 and 39.

It should be noted that description of content that overlaps with the vehicle seats S1 to S12 described above will be omitted.

The vehicle seat S13 is provided with a lumbar support in the seat back and realizes a seat devised so as not to affect the lumbar support being movable even in a case where the pad material and the skin material are fixed with an adhesive.

The vehicle seat S13 includes a seat cushion 2201, a seat back 2202, and a lumbar support 2230 attached in the seat back 2202.

In the seat back 2202, a pad material 2202a and a skin material 2202b are bonded by adhesion portions 2260.

The lumbar support 2230 is a member that supports the seated occupant's lumbar and is disposed on the back surface of a support plate 2225 in the middle portion of the lower part of the seat back 2202. Further, the lumbar support 2230 is a member that is movable for the support plate 2225 and the pad material 2202a to protrude to the seated occupant side.

The adhesion portions 2260 are applied to the front surface of the seat back 2202 and disposed at a predetermined interval in the up to down direction.

In addition, the adhesion portions 2260 elongatedly extend in the seat width direction.

The adhesion portions 2260 are disposed so as to avoid the part of the seat back 2202 that is easily deformed by the lumbar support 2230 being movable (specifically, most easily deformed part).

For example, the most easily deformed part of the seat back 2202 corresponds to the central part (top portion) of the lumbar support 2230.

By forming “non-adhesion region” in this manner, the seat back 2202 can be smoothly displaced when the lumbar support 2230 is movable. Further, it is possible to suppress the seating comfort of the occupant (seated occupant) being affected.

With the above configuration, it is possible to realize the vehicle seat devised so as not to affect the lumbar support 2230 being movable even in a case where the pad material 2202a and the skin material 2202b are fixed with an adhesive.

It should be noted that as illustrated in FIG. 39, the adhesion portion 2260 may be disposed at a position overlapping the part of the seat back 2202 that is deformed by the lumbar support 2230 being movable (specifically, most deformed part).

Even in such a case, the seat back 2202 can be smoothly displaced when the lumbar support 2230 is movable by forming “non-adhesion region” at the part of the skin material 2202b that requires room for extension.

### Fourteenth Embodiment

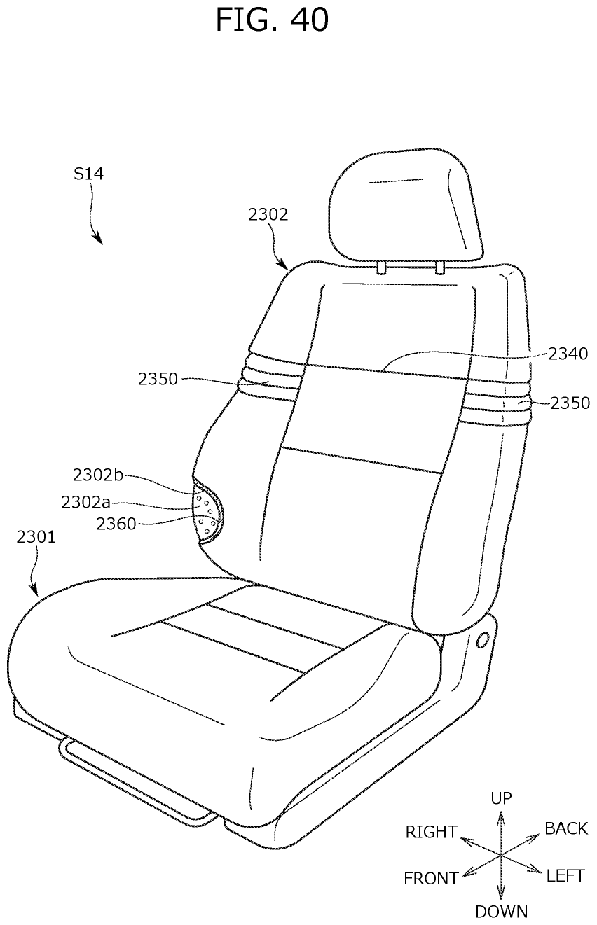

Next, a vehicle seat S14 of a fourteenth embodiment will be described with reference to FIG. 40.

It should be noted that description of content that overlaps with the vehicle seats S1 to S13 described above will be omitted.

The vehicle seat S14 is provided with a seat back movable device in the seat back and realizes a seat devised so as not to affect the seat back movable device being movable even in a case where the pad material and the skin material are fixed with an adhesive.

The vehicle seat S14 includes a seat cushion 2301, a seat back 2302, and a seat back movable device 2340 attached in the seat back 2302.

In the seat back 2302, a pad material 2302a and a skin material 2302b are bonded by an adhesion portion 2360.

The seat back movable device 2340 is a device that is capable of pivoting the upper part of the seat back 2302 forward.

In other words, the seat back 2302 is a center-folding seat back.

In the above configuration, a skin gather portion 2350 is formed at the position in the skin material 2302b that is the boundary part between the upper part and the lower part of the seat back 2302.

The skin gather portion 2350 is, for example, a part that is wrinkled by sewing and contracting a part of the skin material.

The adhesion portion 2360 is disposed in the skin material 2302b so as to avoid the skin gather portion 2350.

By providing “non-adhesion region” in the skin gather portion 2350 in this manner, the seat back 2302 can be smoothly displaced (the skin gather portion 2350 contracts) when the seat back movable device 2340 is movable. In other words, it is possible to suppress irregular wrinkling of the skin material 2302b and keep the appearance of the vehicle seat.

With the above configuration, it is possible to realize the vehicle seat devised so as not to affect the seat back movable device 2340 even in a case where the pad material 2202a and the skin material 2302b are fixed with an adhesive.

Although a vehicle interior component (vehicle seat) that is used in an automobile has been described as a specific example in the above embodiment, the present invention is not particularly limited and is usable with respect to an interior component for two-wheeled vehicles (seat for two-wheeled vehicles) and a vehicle interior component (vehicle seat) for trains, buses, and so on. Alternatively, it is also usable with respect to an interior component (seat) for conveyances such as airplanes and ships.

Although the invention of a vehicle interior component (vehicle door lining) has been described in the above embodiment, it may be the invention of a vehicle interior component manufacturing method.

For example, it may be the invention of a vehicle interior component manufacturing method including a step of attaching a light-emitting member emitting light toward the inside of a vehicle to a base material of a vehicle interior component, a step of attaching a power generation member electrically connected to the light-emitting member to supply electricity to the light-emitting member, and a step of attaching a power storage member electrically connected to the light-emitting member and the power generation member and storing electricity.

At this time, it is preferable that the power generation member is sheet-shaped or film-shaped and disposed along a surface of the vehicle interior component.

By the above method, it is possible to manufacture a vehicle interior component capable of exhibiting an in-vehicle lighting function even without electricity supply from a vehicle body power source.

A vehicle door, a vehicle, and a vehicle manufacturing method have been described in the present embodiment.

However, the above embodiment is merely an example for facilitating understanding of the present invention and does not limit the present invention. It is a matter of course that the present invention can be modified and improved without departing from the spirit thereof and the present invention includes equivalents thereof.

### REFERENCE SIGNS LIST

V Vehicle
D Vehicle door
D1 Door panel
D2 Outer panel
D3 Inner panel
D4 Reinforcement member
   D4a Upper panel attachment portion (panel attachment portion)
   D4b Lower panel attachment portion (panel attachment portion)
   D4c Protruding end portion
P Power source
1, 101, 201, 301, 401, 501, 601, 701 Vehicle door lining (door lining, vehicle interior component)
2, 302 Armrest
3, 703 Operating handle
4 Pocket portion
5 Operating panel
10 Door lining base material
   10a Hinge
11 Armrest base material portion
12 Assembly portion
13 Impact absorbing portion (impact absorbing body)
   13a Outside end portion
   13b Inside end portion
14 Through hole
20, 120 Skin material
21 First skin material
22 Second skin material
30, 130, 230, 330, 430, 530, 630, 730 Light-emitting member (planar light-emitting body)
40 Decorative panel
41 Light-emitting region
50, 150, 250, 350, 450, 550, 650, 750 Power generation member (solar battery module)
51 Solar battery cell
52 Sealing layer
53 Surface layer
54 Film substrate
60, 160, 260, 360, 460, 560, 660, 760 Power storage member (storage battery)
70, 170 Connecting member
71, 171 First connecting member
72, 172 Second connecting member
80, 180 Control controller (control device)
131 Film substrate
132 Light-emitting region
S, S1 to S14 Vehicle seat
   Sa Seat cushion
1001, 1101, 1201, 1301, 1401, 1501, 1601, 1701, 1801, 1901, 2001, 2101, 2201, 2301 Seat cushion
   1001a, 1002a, 1101a, 1201a, 1301a, 1401a, 1501a, 1601a, 1701a, 1802a, 1901a, 2002a, 2101a, 2202a, 2302a
Pad material
   1802aa, 1901aa Pad through hole, Slit groove
   1802ab, 1901ab Inner pad, Front pad
   1802ac, 1901ac Outer pad, Rear pad
1001b, 1002b, 1201b, 1301b, 1401b, 1501b, 1601b, 1701b, 1802b, 1901b, 2002b, 2101b, 2202b, 2302b Skin material
   1802ba Skin burst-open portion
   1802bb Inner skin material
   1802bc Outer skin material
1002, 1102, 1202, 1302, 1402, 1502, 1602, 1702, 1802, 1902, 2002, 2102, 2202, 2302 Seat back
   1002A, 2002A Middle portion
   1002B, 1802B, 2002B Side portion
   1002C, 2002C Pull-in groove
1004 Reclining device
1005 Height link device
1006 Rail device
1010, 1210, 1310, 1410, 1710 Cushion frame
1011, 1711 Side frame
1012 Pan frame
1013 Rear connecting frame
1014, 1714 Support member, Elastic spring
1715 Connecting clip
1020, 1820, 2020 Back frame
1021, 1821, 2021 Back side frame
1022 Upper frame (connecting frame)
1023 Lower frame
1024 Wire member
1025, 2225 Support plate
1030, 2030, 2230 Lumbar support
1031 Base member
1032 Bag body
1040, 2040 Movable body (side support member)
1041 Base member
1042 Pivot shaft
1043 Pivoting member
1044 Bag body
1050 Operating device (fluid supply device)
1051 Air control unit
1052 Air pump
1053 Air pipe
1060, 1160, 1260, 1360, 1460, 1560, 1570, 1660, 1760, 1860, 1860A, 1860B, 1960, 2060, 2160, 2260, 2360
Adhesion portion
1061, 2061, 2161 Middle adhesion portion, Upper adhesion portion
1062, 2062, 2162 First side adhesion portion (side adhesion portion), Front adhesion portion
1063 Second side adhesion portion
1161 Upper surface adhesion portion
1162 Side surface adhesion portion
1070 Surface weak portion
1080 Back surface weak portion
1130, 1230, 1330 Blower device
1131 Blower main body
1132, 1232, 1332 Duct
1133, 1233, 1333 Ventilation path
1134, 1234, 1334 Ventilation hole
1170 Notch portion (duct escape portion)
1235 Attachment bracket
1240, 1440 Detection sensor (seating sensor)
1241 Detection unit
1242 Transmission path
1243, 1443 Attachment bracket
1244, 1444 Sensor storage portion, Sensor storage recess
1550, 1650, 1750 Seat heater
1751 Seat base material
1752 Electric wire
1753 Heater wire
1754 Thermostat
1850, 1950 Side airbag device, Airbag device
1851 Airbag module
1852, 1952 Airbag
1853 Inflator
1854, 1854a, 1854b Guide member (stay cloth)
2140 Cushion length adjustment device
2340 Seat back movable device
2350 Skin gather portion

What is claimed is:

1. A vehicle door provided in a vehicle and comprising:
a door panel serving as a base plate of the vehicle door; and
a door lining attached to a vehicle inside of the door panel, wherein
the door panel has an inner panel disposed on the vehicle inside of the door panel and a reinforcement member attached to a side surface of the inner panel on a vehicle outside, formed so as to protrude to the vehicle outside, and having a U-shaped cross section,
the door lining has an impact absorbing body formed so as to become narrow in a stepwise manner toward the inner panel,
the reinforcement member has a panel attachment portion attached to the side surface of the inner panel on the vehicle outside,
the panel attachment portion is disposed at a position overlapping an outside end portion of the impact absorbing body on the vehicle outside in an up to down direction, and
a middle portion of the reinforcement member in the up to down direction is disposed at a position below an upper end of the outside end portion of the impact absorbing body.

2. The vehicle door according to claim 1, wherein
the outside end portion of the impact absorbing body is provided at a position facing the inner panel and disposed along the inner panel,
the panel attachment portion has an upper panel attachment portion and a lower panel attachment portion disposed at a position below the upper panel attachment portion,
the upper panel attachment portion is disposed between the upper end and a lower end of the outside end portion of the impact absorbing body in the up to down direction, and
the lower panel attachment portion is disposed at a position below the lower end of the outside end portion of the impact absorbing body.

3. The vehicle door according to claim 1, wherein
the panel attachment portion has an upper panel attachment portion and a lower panel attachment portion disposed at a position below the upper panel attachment portion, and
the lower panel attachment portion is disposed at a position overlapping a lower end of an inside end portion of the impact absorbing body on the vehicle inside in the up to down direction.

4. A vehicle, comprising:
the vehicle door according to claim 1; and
a vehicle seat provided in the vehicle, wherein
the vehicle seat has a seat cushion supporting a seated occupant from below, and
a protruding end portion of the reinforcement member on the vehicle outside is disposed at a position above an upper end of the seat cushion.

5. The vehicle according to claim 4, wherein
the panel attachment portion has an upper panel attachment portion and a lower panel attachment portion disposed at a position below the upper panel attachment portion,
an upper end of the upper panel attachment portion is disposed at a position below the upper end of the outside end portion of the impact absorbing body, and
a lower end of the lower panel attachment portion is disposed at a position above the upper end of the seat cushion.

6. A vehicle, comprising:
a vehicle door provided in the vehicle; and
a vehicle seat provided in the vehicle, wherein
the vehicle door includes a door panel serving as a base plate of the vehicle door and a door lining attached to a vehicle inside of the door panel,
the vehicle seat includes a seat cushion supporting a seated occupant from below,
the door panel has an inner panel disposed on the vehicle inside of the door panel and a reinforcement member attached to a side surface of the inner panel on a vehicle outside and formed so as to protrude to the vehicle outside,
the door lining has an impact absorbing body formed so as to become narrow in a stepwise manner toward the inner panel,
an outer end portion of the impact absorbing body on the vehicle outside is disposed at a position above an upper end of the seat cushion,
the reinforcement member has a panel attachment portion attached to the side surface of the inner panel on the vehicle outside, and
the panel attachment portion is disposed at a position overlapping an outside end portion of the impact absorbing body on the vehicle outside in an up to down direction.

7. The vehicle according to claim 6, wherein
the reinforcement member has a U-shaped cross section, and
a middle portion of the reinforcement member in the up to down direction is disposed at a position above the upper end of the seat cushion.

8. The vehicle according to claim 6, wherein
the panel attachment portion has an upper panel attachment portion and a lower panel attachment portion disposed at a position below the upper panel attachment portion,
an upper end of the upper panel attachment portion is disposed at a position below an upper end of the outside end portion of the impact absorbing body, and
a lower end of the lower panel attachment portion is disposed at a position above the upper end of the seat cushion.

9. The vehicle according to claim 7, wherein
the panel attachment portion has an upper panel attachment portion and a lower panel attachment portion disposed at a position below the upper panel attachment portion,
an upper end of the upper panel attachment portion is disposed at a position below an upper end of the outside end portion of the impact absorbing body, and
a lower end of the lower panel attachment portion is disposed at a position above the upper end of the seat cushion.

10. The vehicle according to claim 6, wherein
the outer end portion of the impact absorbing body is provided at a position facing the inner panel and disposed along the inner panel,
the reinforcement member has a U-shaped cross section,
the panel attachment portion has an upper panel attachment portion and a lower panel attachment portion disposed at a position below the upper panel attachment portion,
the upper panel attachment portion is disposed between an upper end and a lower end of the outside end portion of the impact absorbing body in the up to down direction, and
the lower panel attachment portion is disposed at a position below the lower end of the outside end portion of the impact absorbing body.

11. The vehicle according to claim 7, wherein
the outer end portion of the impact absorbing body is provided at a position facing the inner panel and disposed along the inner panel,
the panel attachment portion has an upper panel attachment portion and a lower panel attachment portion disposed at a position below the upper panel attachment portion,
the upper panel attachment portion is disposed between an upper end and a lower end of the outside end portion of the impact absorbing body in the up to down direction, and
the lower panel attachment portion is disposed at a position below the lower end of the outside end portion of the impact absorbing body.

12. The vehicle according to claim 8, wherein
the outer end portion of the impact absorbing body is provided at a position facing the inner panel and disposed along the inner panel,
the panel attachment portion has an upper panel attachment portion and a lower panel attachment portion disposed at a position below the upper panel attachment portion,
the upper panel attachment portion is disposed between the upper end and a lower end of the outside end portion of the impact absorbing body in the up to down direction, and
the lower panel attachment portion is disposed at a position below the lower end of the outside end portion of the impact absorbing body.

13. The vehicle according to claim 6, wherein
the panel attachment portion has an upper panel attachment portion and a lower panel attachment portion disposed at a position below the upper panel attachment portion, and
the lower panel attachment portion is disposed at a position overlapping a lower end of an inside end portion of the impact absorbing body on the vehicle inside in the up to down direction.

14. The vehicle according to claim 7, wherein
the panel attachment portion has an upper panel attachment portion and a lower panel attachment portion disposed at a position below the upper panel attachment portion, and
the lower panel attachment portion is disposed at a position overlapping a lower end of an inside end portion of the impact absorbing body on the vehicle inside in the up to down direction.

15. The vehicle according to claim 8, wherein
the panel attachment portion has an upper panel attachment portion and a lower panel attachment portion disposed at a position below the upper panel attachment portion, and
the lower panel attachment portion is disposed at a position overlapping a lower end of an inside end portion of the impact absorbing body on the vehicle inside in the up to down direction.

16. The vehicle according to claim 10, wherein
the panel attachment portion has an upper panel attachment portion and a lower panel attachment portion disposed at a position below the upper panel attachment portion, and
the lower panel attachment portion is disposed at a position overlapping a lower end of an inside end portion of the impact absorbing body on the vehicle inside in the up to down direction.

17. A method for manufacturing a vehicle including a vehicle door and a vehicle seat, the vehicle door having a door panel serving as a base plate of the vehicle door and a door lining attached to a vehicle inside of the door panel, and the vehicle seat having a seat cushion supporting a seated occupant from below, the method, comprising:
disposing an inner panel configuring the door panel on the vehicle inside of the door panel;
attaching a panel attachment portion of a reinforcement member to a side surface of the inner panel on a vehicle outside and disposing the reinforcement member so as to protrude to the vehicle outside;
causing an impact absorbing body configuring the door lining to protrude so as to become narrow in a stepwise manner toward the inner panel and attaching the impact absorbing body such that an outside end portion of the impact absorbing body on the vehicle outside overlaps the panel attachment portion in an up to down direction; and
attaching the seat cushion such that an outer end portion of the impact absorbing body on the vehicle outside is disposed at a position above an upper end of the seat cushion.
